(19) United States
(12) Patent Application Publication
(10) Pub. No.: US 2015/0185634 A1
(43) Pub. Date: Jul. 2, 2015

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Michiyo Sekiya, Atami-shi (JP); Yota Ito, Mishima-shi (JP); Nobuhiro Nakamura, Numazu-shi (JP)

(21) Appl. No.: 14/568,052

(22) Filed: Dec. 11, 2014

(30) Foreign Application Priority Data
Dec. 26, 2013 (JP) 2013-270566
Dec. 1, 2014 (JP) 2014-243107

(51) Int. Cl. G03G 15/00

(52) U.S. Cl. CPC G03G 5/14

(57) ABSTRACT

An electrophotographic photosensitive member including a support, a first intermediate layer formed on the support, a second intermediate layer formed directly on the first intermediate layer, a charge generating layer formed directly on the second intermediate layer, and a hole transporting layer formed on the charge generating layer, wherein the first intermediate layer contains a binder resin and a titanium oxide particle, and the second intermediate layer contains a polymerized product of a composition including an electron transporting substance having a polymerizable functional group and a crosslinking agent.

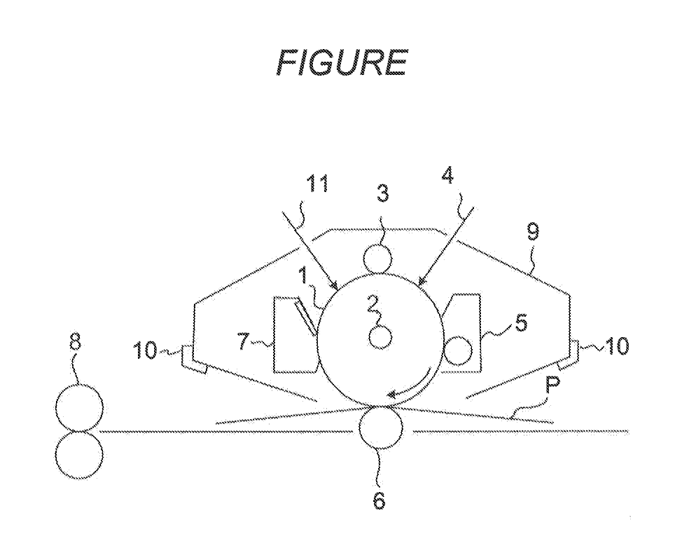

### BACKGROUND OF THE INVENTION

1. Field of the Invention

The present invention relates to an electrophotographic photosensitive member, and a process cartridge and an electrophotographic apparatus including an electrophotographic photosensitive member.

2. Description of the Related Art

Process cartridges and electrophotographic apparatuses are provided with electrophotographic photosensitive members, and currently mostly employ electrophotographic photosensitive members containing organic photoconductive substances. The electrophotographic photosensitive member typically includes a support and a photosensitive layer formed on the support. Between the support and the photosensitive layer, an intermediate layer is provided to suppress injection of charges from the support to the photosensitive layer (charge generating layer) to prevent generation of image defects such as fogging and cover defects on the surface of the support.

Examples of known intermediate layers having electric resistance in an appropriate range include those composed of organic resins such as polyamide resins. Examples thereof also include intermediate layers composed of organic resins and metal oxide particles or metal nitride particles dispersed in the resins. Among these metal oxide particles, titanium oxide particles have higher refractive indices than those of other white pigments. The titanium oxide particles are chemically and physically more stable and have high covering ability. For these reasons, the titanium oxide particles are extensively used as metal oxide particles contained in intermediate layers.

Japanese Patent Application Laid-Open No. 556-52757 describes an intermediate layer containing a titanium oxide particle not surface-treated. Unfortunately, the titanium oxide particle not surface-treated advantageously reduces cost whereas high water absorbing properties (moisture absorbing properties) of the titanium oxide particle may subject resistance of the intermediate layer to fluctuation in potential due to environments. The intermediate layer containing such a titanium oxide particle has insufficient ability to block injection of charges from the support, which may cause leakage.

Japanese Patent Application Laid-Open No. 2012-88430 describes an intermediate layer containing a titanium oxide particle surface-treated with an organic compound. The titanium oxide particle surface-treated reduces the fluctuation in potential due to environments whereas the titanium oxide particle insufficiently surface-treated may insufficiently reduce the fluctuation in potential.

### SUMMARY OF THE INVENTION

An object of the present invention is to provide an electrophotographic photosensitive member including an undercoat layer (intermediate layer) containing titanium oxide particles to reduce fluctuation in potential due to environments and generation of leakage. Another object of the present invention is to provide a process cartridge and an electrophotographic apparatus including the electrophotographic photosensitive member.

The present invention relates to an electrophotographic photosensitive member including: a support, a first intermediate layer formed on the support, a second intermediate layer formed directly on the first intermediate layer, a charge generating layer formed directly on the second intermediate layer, and a hole transporting layer formed on the charge generating layer, wherein the first intermediate layer contains a binder resin and a titanium oxide particle, and the second intermediate layer contains a polymerized product of a composition including: an electron transporting substance having a polymerizable functional group and a crosslinking agent, wherein the content of the electron transporting substance in the second intermediate layer is 25% by mass or more based on the total mass of the composition.

The present invention also relates to a process cartridge integrally supporting the electrophotographic photosensitive member and at least one unit selected from the group consisting of a charging unit, a developing unit and a cleaning unit, the process cartridge being attachable to and detachable from a main body of an electrophotographic apparatus.

The present invention also relates to an electrophotographic apparatus including the electrophotographic photosensitive member, a charging unit, an exposing unit, a developing unit and a transfer unit.

The present invention can provide an electrophotographic photosensitive member that can reduce fluctuation in potential due to environments and generation of leakage, and a process cartridge and an electrophotographic apparatus including the electrophotographic photosensitive member.

Further features of the present invention will become apparent from the following description of exemplary embodiments with reference to the attached drawing.

### BRIEF DESCRIPTION OF THE DRAWINGS

FIGURE is a diagram illustrating one example of a schematic configuration of an electrophotographic apparatus provided with a process cartridge including the electrophotographic photosensitive member according to the present invention.

### DESCRIPTION OF THE EMBODIMENTS

Preferred embodiments of the present invention will now be described in detail in accordance with the accompanying drawing.

The electrophotographic photosensitive member according to the present invention includes a support, a first intermediate layer formed on the support, a second intermediate layer formed directly on the first intermediate layer, a charge generating layer formed directly on the second intermediate layer, and a hole transporting layer formed on the charge generating layer.

In the electrophotographic photosensitive member according to the present invention, the first intermediate layer contains a binder resin and a titanium oxide particle, and the second intermediate layer contains a polymerized product of a composition including an electron transporting substance having a polymerizable functional group and a crosslinking agent. In addition to these features, the content of the electron transporting substance in the second intermediate layer is 25% by mass or more based on the total mass of the composition.

The present inventors consider that the electrophotographic photosensitive member according to the present invention reduces fluctuation in potential due to environments and generation of leakage probably for the following reasons.

If a titanium oxide particle whose surface has not been treated or surface has been treated with a small amount of a surface treating agent is used in an intermediate layer (first intermediate layer), high water absorbing properties of the intermediate layer fluctuate the resistance of the intermediate layer due to environments. The Vl potential (bright potential) readily changes due to environments. Of photocarriers generated in the charge generating layer, holes move toward the surface and electrons move toward the support in one cycle of an electrophotographic process. The number of movable holes and the number of movable electrons are varied depending on the environment. Of the photocarriers generated in the charge generating layer, as the amount of movable electrons changes according to the resistance of the intermediate layer, the amount of movement of holes toward the surface, which determines the Vl potential, also changes. The present inventors consider that this environmental dependency of the potential is caused for such reasons.

In the present invention, the second intermediate layer containing a polymerized product of a composition including an electron transporting substance having a polymerizable functional group and a crosslinking agent is used. Electrons move due to the structure derived from the electron transporting substance in the second intermediate layer. Furthermore, it seems that formation of the polymerized product significantly reduces a change in the electron moving ability due to environmental changes caused by a reduction in water absorbing properties.

The present inventors think that in the present invention, the second intermediate layer is disposed between the first intermediate layer containing a titanium oxide particle and the charge generating layer, and such an arrangement leads to the following phenomenon. The second intermediate layer disposed between the first intermediate layer and the charge generating layer is barely affected by the environment, thus reducing environmental influences on the movement of electrons in the movement of the photocarriers (electrons) generated in the charge generating layer to the first intermediate layer. This reduces an environmental change in the amount of movement of holes toward the surface to reduce a change in the Vl potential.

When a titanium oxide particle not surface-treated or insufficiently surface-treated is used in the intermediate layer (first intermediate layer), breakdown during dark may occur. The present inventors think that this is because charges locally concentrate during Vd potential (dark potential) to cause injection of holes from the surfaces of the titanium oxide particles to the charge generating material.

Probably, the second intermediate layer disposed between the first intermediate layer and the charge generating layer reduces contact points between the charge generating substance and titanium oxide particles not surface-treated or insufficiently surface-treated, so that injection of holes is suppressed, and thus generation of leakage is reduced.

The second intermediate layer contains a polymerized product of a composition including an electron transporting substance having a polymerizable functional group and a crosslinking agent. Namely, the electron transporting substance is polymerized to form a three-dimensional net structure, which probably allows a layer disposed between the first intermediate layer and the charge generating layer to sufficiently demonstrate its function. Probably because the content of the electron transporting substance is 25% by mass or more, a sufficient three-dimensional net structure is attained to suppress injection of holes.

The electrophotographic photosensitive member according to the present invention will now be described in more detail.

[Support]

A support can have conductivity (conductive support). A support composed of a metal such as aluminum, nickel, copper, gold and iron or an alloy thereof can be used. Examples thereof include insulating supports composed of polyester resins, polycarbonate resins, polyimide resins and glass and having metal thin films of aluminum, silver and gold formed thereon; or supports having thin films of conductive materials such as indium oxide and tin oxide formed thereon.

The surface of the support may be subjected to an electrochemical treatment such as anode oxidation, wet honing, blasting or machining to improve electrical properties or suppress interference fringes.

[First Intermediate Layer]

A first intermediate layer is provided between the support and a second intermediate layer.

In the present invention, the first intermediate layer contains a binder resin and a titanium oxide particle.

The titanium oxide particle used in the present invention can be a titanium oxide particle not surface-treated or insufficiently surface-treated. The effect of the present invention attained by the second intermediate layer disposed between the first intermediate layer and the charge generating layer can be demonstrated more effectively when titanium oxide not surface-treated is used. The titanium oxide particle insufficiently surface-treated specifically indicates a titanium oxide particle surface-treated with more than 0% by mass and 5% by mass or less surface treating agent. Examples of the surface treating agent used here include titanium coupling agents, aluminum coupling agents and silane coupling agents.

Examples of binder resins used in the first intermediate layer include resins such as phenol resins, polyurethane, polyamide, polyimide, polyamideimide, polyvinyl acetal, epoxy resins, acrylic resins, melamine resins and polyester. These may be used singly or in combinations of two or more.

Examples of usually commercially available titanium oxide particles not surface-treated as a titanium oxide particle used in the first intermediate layer include TTO-55N (manufactured by Ishihara Sangyo Kaisha, Ltd.), CR-EL (manufactured by Ishihara Sangyo Kaisha, Ltd.) and TITANIX-JR (manufactured by Tayca Corporation).

Titanium oxide may be in any form of rutile, anatase, brookite and amorphous crystals. Titanium oxide can be needle-like crystals or particulate crystals. These may be used singly or as a mixture.

The volume average particle size of the titanium oxide particle contained in the first intermediate layer is preferably 260 nm or less to further enhance the effect of reducing environmental fluctuations. The volume average particle size is more preferably 30 nm or more.

The volume average particle size is measured at a proper magnification in observation with a transmission electron microscope (TEM). The volume average particle size is determined as follows: 100 primary particles only, excluding secondary aggregated particles, are observed to determine projected areas thereof; and equivalent circle diameters of the determined areas are calculated to determine the volume average particle size.

The first intermediate layer may contain metal oxide particles other than the titanium oxide particle. Examples of metal oxide particles other than the titanium oxide particle include zinc oxide, lead white, aluminum oxide, indium oxide, silicon oxide, zirconium oxide, tin oxide, titanium oxide, magnesium oxide, antimony oxide, bismuth oxide, silicon oxide, indium oxide doped with tin, tin oxide doped with antimony or tantalum, and zirconium oxide.

The first intermediate layer can be formed by applying a coating solution for a first intermediate layer containing a solvent, a binder resin and the titanium oxide particle onto a support to form a coating, and drying and/or curing the coating.

The coating solution for a first intermediate layer can be prepared by dispersing the titanium oxide particle and a binder resin in a solvent. Examples of the method for dispersion include methods with paint shakers, sand mills, ball mills and solution-colliding high speed dispersing machines.

Examples of the solvent used in the coating solution for a first intermediate layer include alcohols such as methanol, ethanol and isopropanol; ketones such as acetone, methyl ethyl ketone and cyclohexanone; ethers such as tetrahydrofuran, dioxane, ethylene glycol monomethyl ether and propylene glycol monomethyl ether; esters such as methyl acetate and ethyl acetate; and aromatic hydrocarbons such as toluene and xylene.

The first intermediate layer has a thickness of preferably 0.1 to 20 μm, more preferably 0.5 to 10 μm. A thickness within this range efficiently reduces the fluctuation in potential due to environments and reduces accumulation of residual charges.

In the present invention, the thicknesses of the respective layers including the first intermediate layer in the electrophotographic photosensitive member were measured with FISHERSCOPE mms manufactured by Fischer Instruments K.K. as a thickness measurement apparatus.

[Second Intermediate Layer]

The second intermediate layer is provided directly on the first intermediate layer.

In the present invention, the second intermediate layer contains a polymerized product (cured product) of a composition including an electron transporting substance having a polymerizable functional group and a crosslinking agent. The content of the electron transporting substance having a polymerizable functional group is 25% by mass or more based on the total mass of the composition.

The composition may further contain a thermoplastic resin having a polymerizable functional group.

In the method of forming the second intermediate layer, first, a coating solution for a second intermediate layer containing a composition of an electron transporting substance having a polymerizable functional group, a crosslinking agent, and optionally a thermoplastic resin having a polymerizable functional group is applied to form a coating. Next, the coating can be dried by heating to polymerize (cure) the coating to form a second intermediate layer. In the present invention, a polymerized product (cured product) of a composition is barely eluted in a solvent (is highly solvent-resistant) as shown in the elution test in Examples below.

The heating temperature during drying the coating of the coating solution for a second intermediate layer by heating can be 100 to 200° C.

Examples of the electron transporting substance include quinone compounds, imide compounds, benzimidazole compounds and cyclopentadienylidene compounds. The electron transporting substance has a polymerizable functional group. Examples of the polymerizable functional group include a hydroxy group, a thiol group, an amino group, a carboxyl group or a methoxy group. Specific examples of the electron transporting substance include compounds represented by one of Formulae (A1) to (A11) illustrated below:

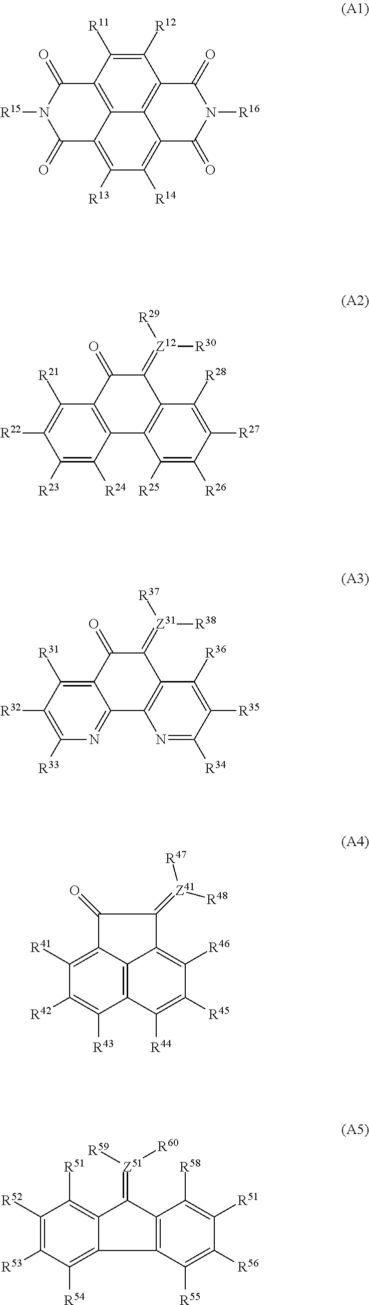

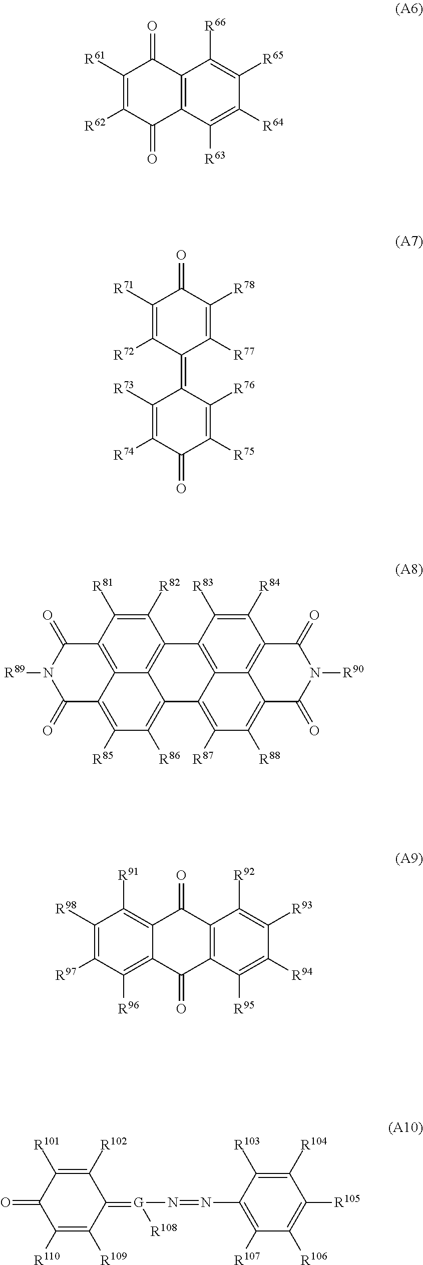

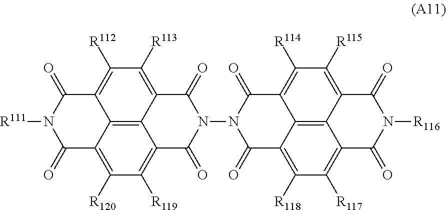

where R¹¹ to R¹⁶, R²¹ to R³⁰, R³¹ to R³⁸, R⁴¹ to R⁴⁸, R⁵¹ to R⁶⁰, R⁶¹ to R⁶⁶, R⁷¹ to R⁷⁸, R⁸¹ to R⁹⁰, R⁹¹ to R⁹⁸, R¹⁰¹ to R¹¹⁰ and R^{11l} to R¹²⁰ each independently represent a monovalent group represented by Formula (A) illustrated below, a hydrogen atom, a cyano group, a nitro group, a halogen atom, an alkoxycarbonyl group, a substituted or unsubstituted alkyl group, a substituted or unsubstituted aryl group, a substituted or unsubstituted heterocyclic group, or a monovalent group derived by replacing one carbon atom in the main chain of a substituted or unsubstituted alkyl group with O, S, NH or NR¹²¹ where R¹²¹ is an alkyl group;

at least one of R¹¹ to R¹⁶, at least one of R²¹ to R³⁰, at least one of R³¹ to R³⁸, at least one of R⁴¹ to R⁴⁸, at least one of R⁵¹ to R⁶⁰, at least one of R⁶¹ to R⁶⁶, at least one of R⁷¹ to R⁷⁸, at least one of R⁸¹ to R⁹⁰, at least one of R⁹¹ to R⁹⁸, at least one of R¹⁰¹ to R¹¹⁰ and at least one of R¹¹¹ to R¹²⁰ have a monovalent group represented by Formula (A); the substituent for a substituted alkyl group is an alkyl group, an aryl group, a halogen atom or an alkoxycarbonyl group; the substituent for a substituted aryl group and the substituent for a substituted heterocyclic group are each a halogen atom, a nitro group, a cyano group, an alkyl group, a halogen-substituted alkyl group or an alkoxy group; Z²¹, Z³¹, Z⁴¹ and Z⁵¹ each independently represent a carbon atom, a nitrogen atom or an oxygen atom; where Z²¹ is an oxygen atom, R²⁹ and R³⁰ are not present; where Z²¹ is a nitrogen atom, R³⁰ is not present; where Z³¹ is an oxygen atom, R³⁷ and R³⁸ are not present; where Z³¹ is a nitrogen atom, R³⁸ is not present; where Z⁴¹ is an oxygen atom, R⁴⁷ and R⁴⁸ are not present; where Z⁴¹ is a nitrogen atom, R⁴⁸ is not present; where Z⁵¹ is an oxygen atom, R⁵⁹ and R⁶² are not present; and where Z⁵¹ is a nitrogen atom, R⁶⁰ is not present;

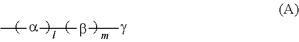

where at least one of α, β and γ is a group having a polymerizable functional group; the polymerizable functional group is at least one group selected from the group consisting of a hydroxy group, a thiol group, an amino group, a carboxyl group and a methoxy group; 1 and m are each independently 0 or 1; the sum of 1 and m is 0 or more and 2 or less;

α represents a substituted or unsubstituted alkylene group having 1 to 6 carbon atoms in the main chain or a monovalent group derived by replacing one carbon atom in the main chain of a substituted or unsubstituted alkylene group having 1 to 6 carbon atoms in the main chain with O, S or NR¹²² where R¹²² represents a hydrogen atom or an alkyl group; the substituent for the alkylene group represents an alkyl group having 1 to 6 carbon atoms, a benzyl group, an alkoxy carbonyl group or a phenyl group; these groups may have at least one group selected from the group consisting of a hydroxy group, a thiol group, an amino group and a carboxyl group as a polymerizable functional group;

β represents a phenylene group, a phenylene group substituted with an alkyl group having 1 to 6 carbon atoms, a nitro group-substituted phenylene group, a halogen group-substituted phenylene group or an alkoxy group-substituted phenylene group; these groups may have at least one group selected from the group consisting of a hydroxy group, a thiol group, an amino group, a carboxyl group and a methoxy group as a polymerizable functional group; and

γ represents a hydrogen atom, a substituted or unsubstituted alkyl group having 1 to 6 carbon atoms in the main chain, or a monovalent group derived by replacing one carbon atom in the main chain of a substituted or unsubstituted alkyl group having 1 to 6 carbon atoms in the main chain with O, S or NR¹²³ where R¹²³ represents a hydrogen atom or an alkyl group; examples of the substituent for the alkyl group include alkyl groups having to 6 carbon atoms; these groups may have at least one group selected from the group consisting of a hydroxy group, a thiol group, an amino group, a carboxyl group and a methoxy group as a polymerizable functional group.

Specific examples of the electron transporting substance having a polymerizable functional group are illustrated below. In the tables, structural units in A and Aa are represented by the same structural formulae. Specific examples of the monovalent group are illustrated in columns A and Aa. In the tables, when γ is “-,” γ represents a hydrogen atom. The hydrogen atom as γ is illustrated in a structure in column α or β.

TABLE 1

| Ex- | | | | | | | | | | | | |
|---|---|---|---|---|---|---|---|---|---|---|---|---|
| em- | | | | | | | | | | | | |
| plary | | | | | | | | | | | | |
| com- | | | | | | | A | | | Aa | | |
| pound | R¹¹ | R¹² | R¹³ | R¹⁴ | R¹⁵ | R¹⁶ | α | β | γ | α | β | γ |
| A101 | H | H | H | H | 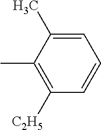 | A | 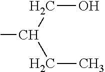 | — | — | — | — | — |
| A102 | H | H | H | H | 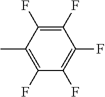 | A | 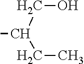 | — | — | — | — | — |
| A103 | H | H | H | H | 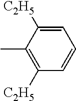 | A | — | 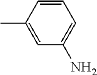 | — | — | — | — |
| A104 | H | H | H | H | 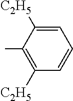 | A | — | 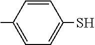 | — | — | — | — |
| A105 | H | H | H | H | 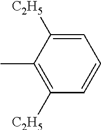 | A | 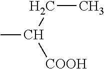 | — | — | — | — | — |
| A106 | H | H | H | H | A | A | 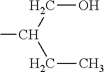 | — | — | — | — | — |
| A107 | H | H | H | H | A | A | 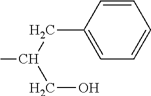 | — | — | — | — | — |
| A108 | H | H | H | H | 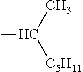 | A | 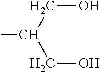 | — | — | — | — | — |
| A109 | H | H | H | H | 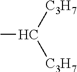 | A | 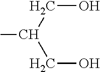 | — | — | — | — | — |
| A110 | H | H | H | H | 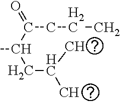 | A | 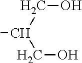 | — | — | — | — | — |
| A111 | H | H | H | H | 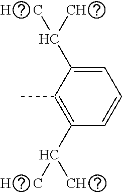 | A | 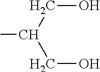 | — | — | — | — | — |
| A112 | H | H | H | H | 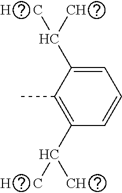 | A | 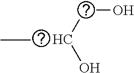 | — | — | — | — | — |
| A113 | H | H | H | H | A | A | 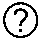 | — | — | — | — | — |
| A114 | H | H | H | H | A | A | 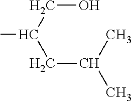 | — | — | — | — | — |
| A115 | H | H | H | H | A | Aa | — [symbol] —S— [symbol] —OH | — | — | 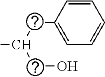 | — | — |
| A116 | H | H | H | H | A | Aa | 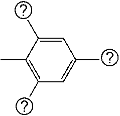 | — | — | 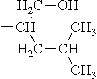 | — | — |
| A117 | H | H | H | H | A | Aa | — | 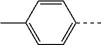 | —CH₂—OH | 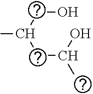 | — | — |
| A118 | H | H | H | H | A | Aa | — | 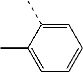 | —CH₂—OH | 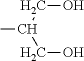 | — | — |
| A119 | H | H | H | H | A | Aa | 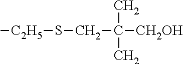 | — | — | 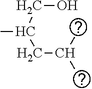 | — | — |
| A120 | H | H | H | H | A | A | 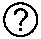 | — | — | — | — | — |

[symbol]

indicates data missing or illegible when filed

TABLE 2

| Exemplary | | | | | | | | | | | | A | | |
|---|---|---|---|---|---|---|---|---|---|---|---|---|---|---|
| compound | R²¹ | R²² | R²³ | R²⁴ | R²⁵ | R²⁶ | R²⁷ | R²⁸ | R²⁹ | R³⁰ | Z³¹ | α | β | γ |
| A201 | H | H | A | H | H | H | H | H | — | — | O | — | 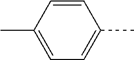 | 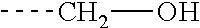 |
| A202 | H | H | H | H | H | H | H | H | A | — | N | — | 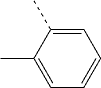 | 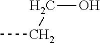 |
| A203 | H | H | 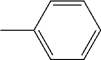 | H | H | 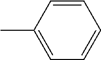 | H | H | A | — | N | — | 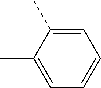 | 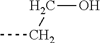 |
| A204 | H | H | 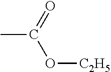 | H | H | 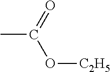 | H | H | A | — | N | — | 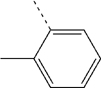 | 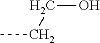 |
| A205 | H | H | A | H | H | A | H | H | — | — | O | — | 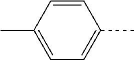 | 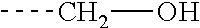 |
| A206 | H | A | H | H | H | H | A | H | — | — | O | — | 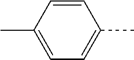 | 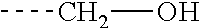 |

TABLE 3

| Exemplary | | | | | | | | | | A | | |
|---|---|---|---|---|---|---|---|---|---|---|---|---|
| compound | R³¹ | R³² | R³³ | R³⁴ | R³⁵ | R³⁶ | R³⁷ | R³⁸ | Z³¹ | α | β | γ |
| A301 | H | A | H | H | H | H | — | — | O | — | 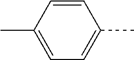 | 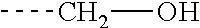 |
| A302 | H | H | H | H | H | H | A | — | N | — | 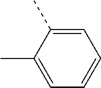 | 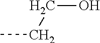 |
| A303 | H | H | H | H | H | H | A | — | N | 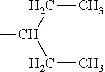 | — | — |
| A304 | H | H | Cl | Cl | H | H | A | — | N | — | 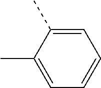 | 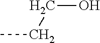 |
| A305 | H | A | H | H | A | H | CN | CN | C | — | 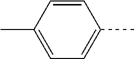 | 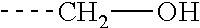 |

TABLE 4

| Exemplary | | | | | | | | | | A | | |
|---|---|---|---|---|---|---|---|---|---|---|---|---|
| compound | R⁴¹ | R⁴² | R⁴³ | R⁴⁴ | R⁴⁵ | R⁴⁶ | R⁴⁷ | R⁴⁸ | Z⁴¹ | α | β | γ |
| A401 | H | H | A | H | H | H | CN | CN | C | — | 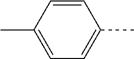 | 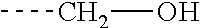 |
| A402 | H | H | H | H | H | H | A | — | N | — | 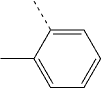 | 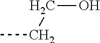 |
| A403 | H | H | A | A | H | H | CN | CN | C | — | 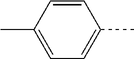 | 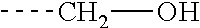 |
| A404 | H | H | A | A | H | H | CN | CN | C | — | 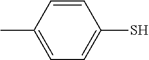 | — |
| A405 | H | H | A | A | H | H | — | — | O | — | 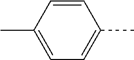 | 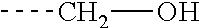 |

TABLE 5

| Exemplary | | | | | | | | | | | | A | | |
|---|---|---|---|---|---|---|---|---|---|---|---|---|---|---|
| compound | R⁵¹ | R⁵² | R⁵³ | R⁵⁴ | R⁵⁵ | R⁵⁶ | R⁵⁷ | R⁵⁸ | R⁵⁹ | R⁶⁰ | Z⁵¹ | α | β | γ |
| A501 | H | A | H | H | H | H | H | H | CN | CN | C | — | 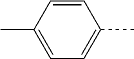 | — |
| A502 | H | NO₂ | H | H | NO₂ | H | NO₂ | H | A | — | N | — | 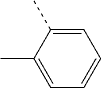 | 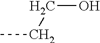 |
| A503 | H | A | H | H | H | H | A | H | CN | CN | C | 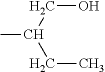 | — | — |
| A504 | H | H | A | H | H | A | H | H | CN | CN | C | — | 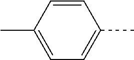 | |

TABLE 6

| Exemplary | | | | | | | A | | |
|---|---|---|---|---|---|---|---|---|---|
| compound | R⁶¹ | R⁶² | R⁶³ | R⁶⁴ | R⁶⁵ | R⁶⁶ | α | β | γ |
| A601 | A | H | H | H | H | H | — | 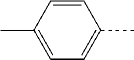 | 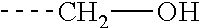 |
| A602 | A | H | H | H | H | H | — | 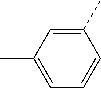 | 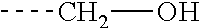 |
| A603 | A | H | H | H | H | H | 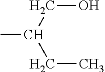 | — | — |
| A604 | A | A | H | H | H | H | — | 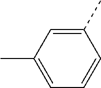 | 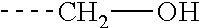 |
| A605 | A | A | H | H | H | H | 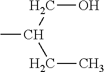 | — | — |

TABLE 7

| Ex- | | | | | | | | | | | | | | |
|---|---|---|---|---|---|---|---|---|---|---|---|---|---|---|
| em- | | | | | | | | | | | | | | |
| plary | | | | | | | | | | | | | | |
| com- | | | | | | | | | A | | | Aa | | |
| pound | R⁷¹ | R⁷² | R⁷³ | R⁷⁴ | R⁷⁵ | R⁷⁶ | R⁷⁷ | R⁷⁸ | α | β | γ | α | β | γ |
| A701 | A | H | H | H | H | H | H | H | — | 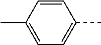 | 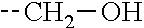 | — | — | — |
| A702 | A | H | H | H | H | H | H | H | 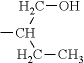 | — | — | — | — | — |
| A703 | A | H | H | H | A | H | H | H | — | 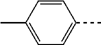 | 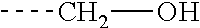 | — | — | — |
| A704 | A | H | H | H | Aa | H | H | H | 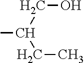 | — | — | — | 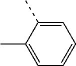 | 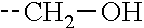 |
| A705 | A | H | H | H | Aa | H | H | H | — | 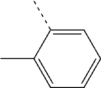 | 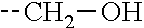 | 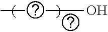 | — | — |

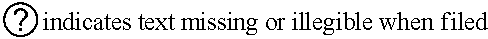

TABLE 8

| Exemplary | | | | | | | | | | | A | | |
|---|---|---|---|---|---|---|---|---|---|---|---|---|---|
| compound | R⁸¹ | R⁸² | R⁸³ | R⁸⁴ | R⁸⁵ | R⁸⁶ | R⁸⁷ | R⁸⁸ | R⁸⁹ | R⁹⁰ | α | β | γ |
| A801 | H | H | H | H | H | H | H | H | 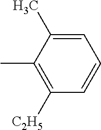 | A | 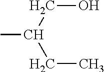 | — | — |
| A802 | H | H | H | H | H | H | H | H | 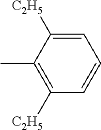 | A | — | 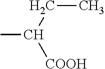 | — |
| A803 | H | CN | H | H | H | H | CN | H | 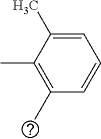 | A | 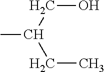 | — | — |
| A804 | H | H | H | H | H | H | H | H | A | A | 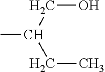 | — | — |
| A805 | H | H | H | H | H | H | H | H | A | A | — | 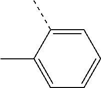 | 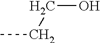 |

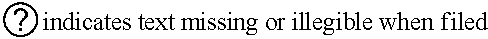

TABLE 9

| Exemplary | | | | | | | | | A | | |
|---|---|---|---|---|---|---|---|---|---|---|---|
| compound | R⁹¹ | R⁹² | R⁹³ | R⁹⁴ | R⁹⁵ | R⁹⁶ | R⁹⁷ | R⁹⁸ | α | β | γ |
| A901 | A | H | H | H | H | H | H | H | —CH₂—OH | — | — |
| A902 | A | H | H | H | H | H | H | H | 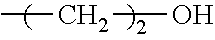 | — | — |
| A903 | H | H | H | H | H | H | H | A | —CH₂—OH | — | — |
| A904 | H | H | H | H | H | H | H | A | 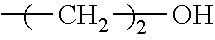 | — | — |
| A905 | H | CN | H | H | H | H | CN | A | — | 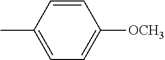 | — |
| A906 | A | A | H | NO₂ | H | H | NO₂ | H | 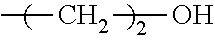 | — | — |
| A907 | H | A | A | H | H | H | H | H | —CH₂—OH | — | — |

TABLE 10

| Exem- | | | | | | | | | | | | | |
|---|---|---|---|---|---|---|---|---|---|---|---|---|---|
| plary | | | | | | | | | | | | | |
| com- | | | | | | | | | | | A | | |
| pound | R¹⁰¹ | R¹⁰² | R¹⁰³ | R¹⁰⁴ | R¹⁰⁵ | R¹⁰⁶ | R¹⁰⁷ | R¹⁰⁸ | R¹⁰⁹ | R¹¹⁰ | α | β | γ |
| A1001 | 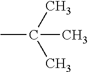 | H | H | H | A | H | H | H | H | 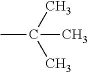 | —CH₂—OH | — | — |
| A1002 | 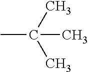 | H | H | H | A | H | H | H | H | 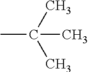 | — | 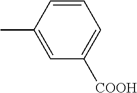 | — |
| A1003 | 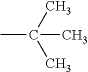 | H | H | H | A | H | H | H | H | 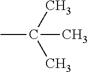 | — | 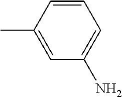 | — |
| A1004 | 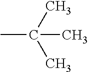 | H | H | H | A | H | H | H | H | 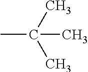 | — | 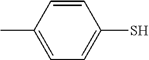 | — |
| A1005 | 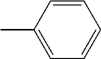 | H | H | H | A | H | H | H | H | 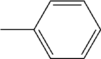 | —CH₂—OH | — | — |

TABLE 11

| Ex- | | | | | | | | | | | | | |
|---|---|---|---|---|---|---|---|---|---|---|---|---|---|
| em- | | | | | | | | | | | | | |
| plary | | | | | | | | | | | | | |
| com- | | | | | | | | | | | A | | |
| pound | R¹¹¹ | R¹¹² | R¹¹³ | R¹¹⁴ | R¹¹⁵ | R¹¹⁶ | R¹¹⁷ | R¹¹⁸ | R¹¹⁹ | R¹²⁰ | α | β | γ |
| A1101 | A | H | H | H | H | A | H | H | H | H | 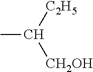 | — | — |
| A1102 | A | H | H | H | H | A | H | H | H | H | 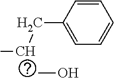 | — | — |
| A1103 | A | H | H | H | H | A | H | H | H | H | — | 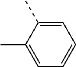 | 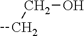 |
| A1104 | A | H | H | H | H | 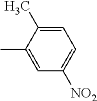 | H | H | H | H | 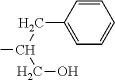 | — | — |
| A1105 | A | H | H | H | H | 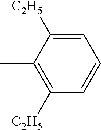 | H | H | H | H | 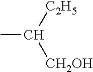 | — | — |

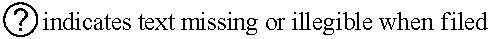

Derivatives having one of structures represented by (A2) to (A6) and (A9) (derivatives of the electron transporting substance) are available from Tokyo Chemical Industry Co., Ltd., Sigma-Aldrich Japan K.K. and Johnson Matthey Japan G.K. A derivative having a structure represented by (A1) can be synthesized by reaction of naphthalene tetracarboxylic dianhydride available from Tokyo Chemical Industry Co., Ltd. or Johnson Matthey Japan G.K. with a monoamine derivative. A derivative having a structure represented by (A7) can be synthesized from a phenol derivative as a raw material available from Tokyo Chemical Industry Co., Ltd. or Sigma-Aldrich Japan K.K. A derivative having a structure represented by (A8) can be synthesized by reaction of perylene tetracarboxylic dianhydride available from Tokyo Chemical Industry Co., Ltd. or Johnson Matthey Japan G.K. with a monoamine derivative. A derivative having a structure represented by (A10) can be synthesized by a known synthetic method described in Japanese Patent No. 3717320 by oxidizing a phenol derivative having a hydrazone structure in an organic solvent with an appropriate oxidizing agent such as potassium permanganate. A derivative having a structure represented by (A11) can be synthesized by reaction of naphthalene tetracarboxylic dianhydride available from Tokyo Chemical Industry Co., Ltd., Sigma-Aldrich Japan K.K. or Johnson Matthey Japan G.K. with a monoamine derivative and hydrazine.

A compound represented by one of (A1) to (A11) has a polymerizable functional group (a hydroxy group, a thiol group, an amino group, a carboxyl group and a methoxy group) polymerizable with a crosslinking agent. A polymerizable functional group is introduced into a derivative having one of the structures represented by (A1) to (A11) to synthesize a corresponding compound represented by one of (A1) to (A11). Examples of the method include the following methods such as a method of synthesizing a derivative having one of the structures represented by (A1) to (A11), and directly introducing a polymerizable functional group into the derivative; and a method of introducing a structure having a polymerizable functional group or a functional group that can serve as a precursor of the polymerizable functional group. Examples of the latter method include a method of introducing an aryl group having a functional group into a halide of a derivative having one of the structures represented by (A1) to (A11) by crosscoupling reaction in the presence of a palladium catalyst and a base; a method of introducing an alkyl group having a functional group into a halide of a derivative having one of the structures represented by (A1) to (A11) by crosscoupling reaction in the presence of an FeCl₃ catalyst and a base; and a method of lithiating a halide of a derivative having one of the structures represented by (A1) to (A11), making an epoxy compound or CO₂ on the halide, and introducing a hydroxyalkyl group or a carboxyl group into the halide.

The electron transporting substance having a polymerizable functional group can have two or more polymerizable functional groups in the molecule.

Next, a crosslinking agent will be described.

For the crosslinking agent, compounds polymerizable or crosslinkable with the electron transporting substance having a polymerizable functional group and a thermoplastic resin having a polymerizable functional group can be used. Namely, the crosslinking agent has a functional group reactive with a polymerizable functional group in the electron transporting substance. Specifically, compounds described in “Crosslinking Agent Handbook” (1981), edited by Shinzo Yamashita and Tosuke Kaneko, published by Taiseisha Ltd. can be used, for example.

The crosslinking agent used in the second intermediate layer can be an isocyanate compound or an amine compound. The crosslinking agent can be an isocyanate compound having 2 to 6 isocyanate groups or block isocyanate groups. Examples thereof include triisocyanate benzene, triisocyanate methylbenzene, triphenylmethane triisocyanate and lysine triisocyanate; isocyanurate modified products, biuret modified products, and allophanate modified products of diisocyanates such as tolylene diisocyanate, hexamethylene diisocyanate, dicyclohexylmethane diisocyanate, naphthalene diisocyanate diphenylmethane diisocyanate, isophorone diisocyanate, xylylene diisocyanate, 2,2,4-trimethylhexamethylene diisocyanate, methyl-2,6-diisocyanate hexanoate and norbornane diisocyanate; and adduct modified products with trimethylolpropane and pentaerythritol. Among these, isocyanurate modified products and adduct modified products can be used.

The block isocyanate group has a structure —NHCOX¹ where X¹ is a protecting group. X¹ can be any protecting group that can be introduced into an isocyanate group. Groups represented by Formulae (H1) to (H7) illustrated below are preferred.

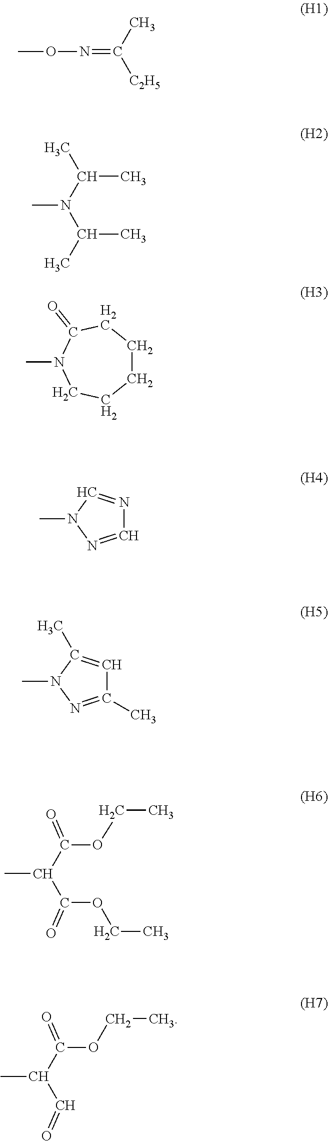

Specific examples of isocyanate compounds (B1) to (B21) are:

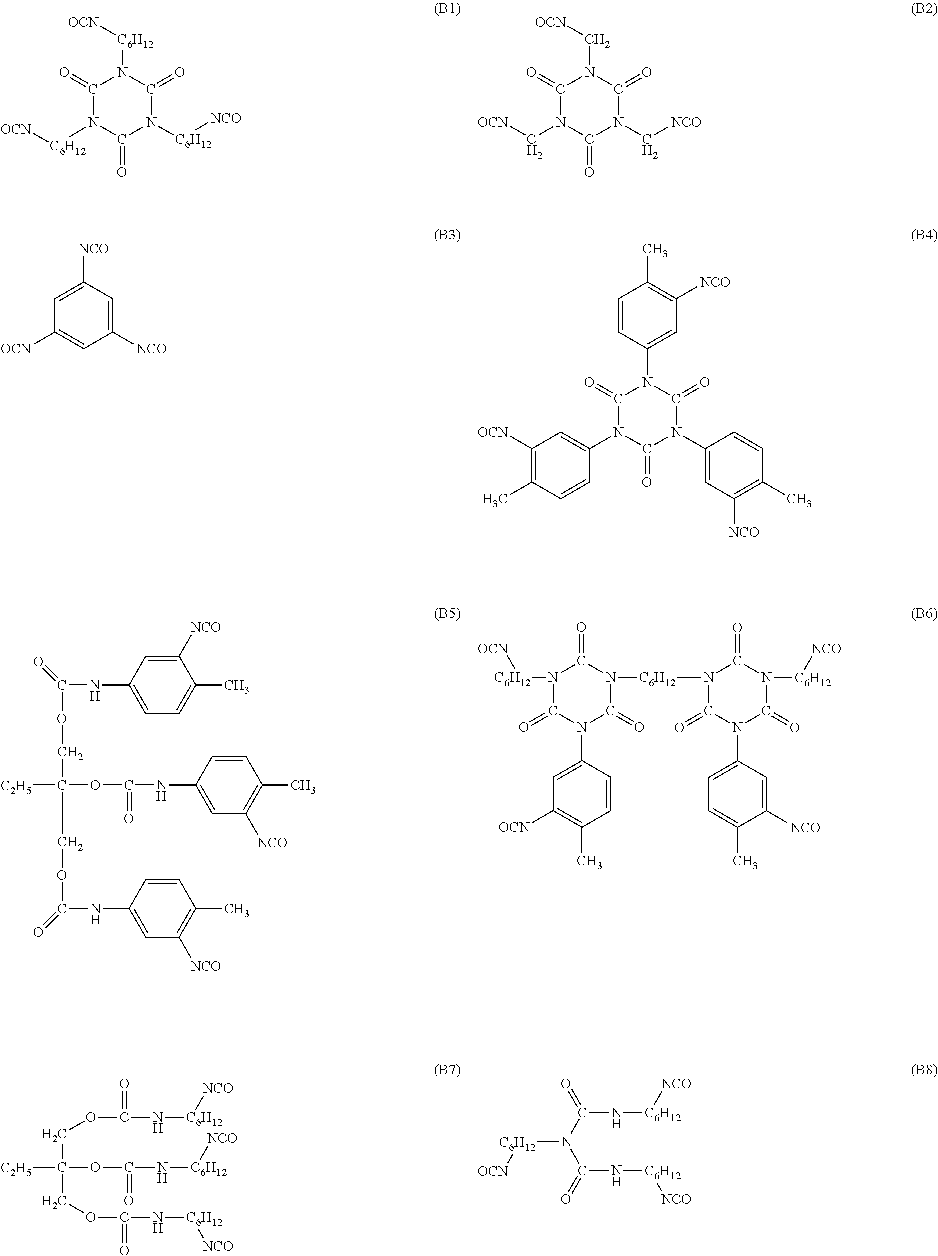

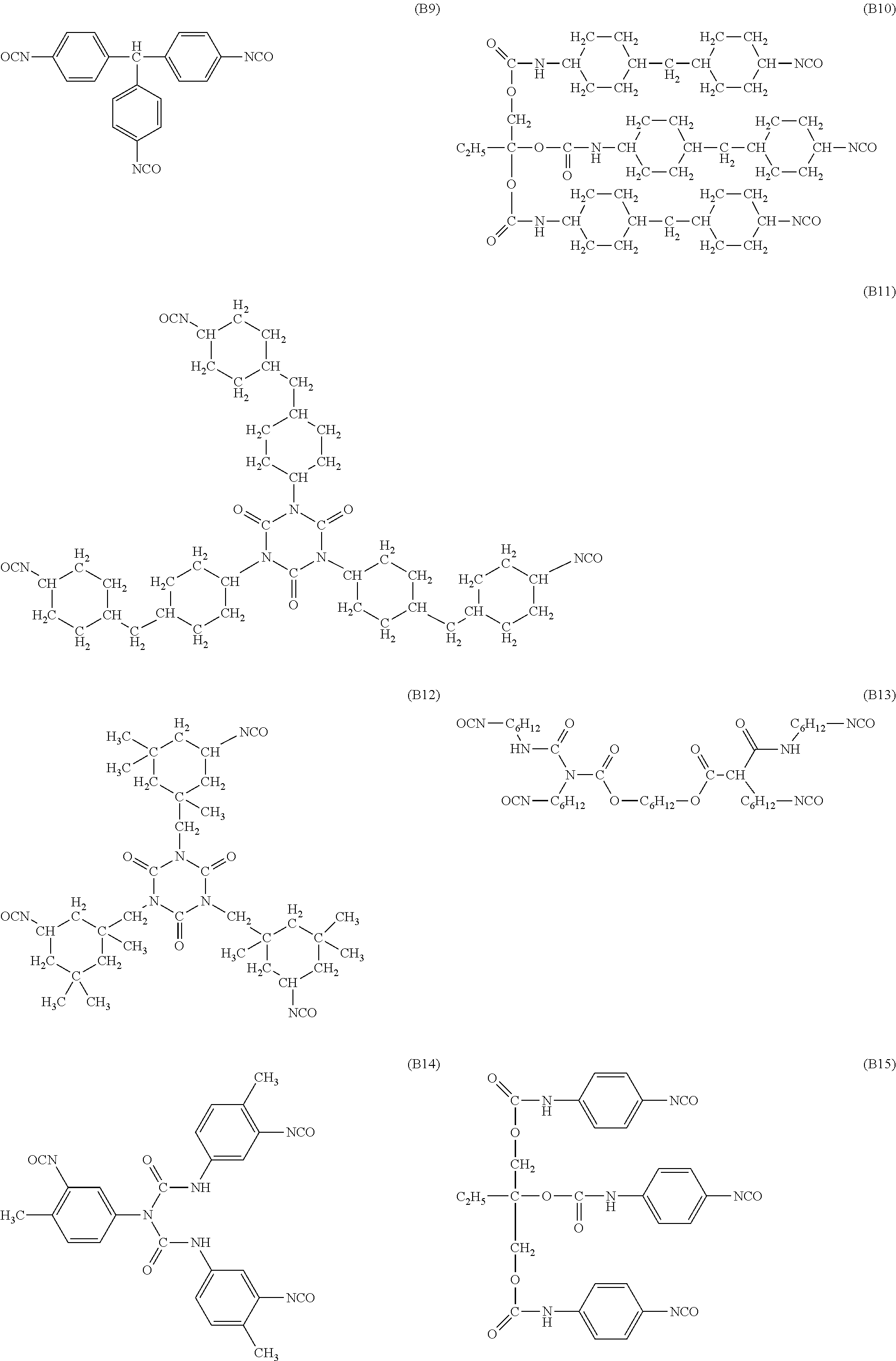

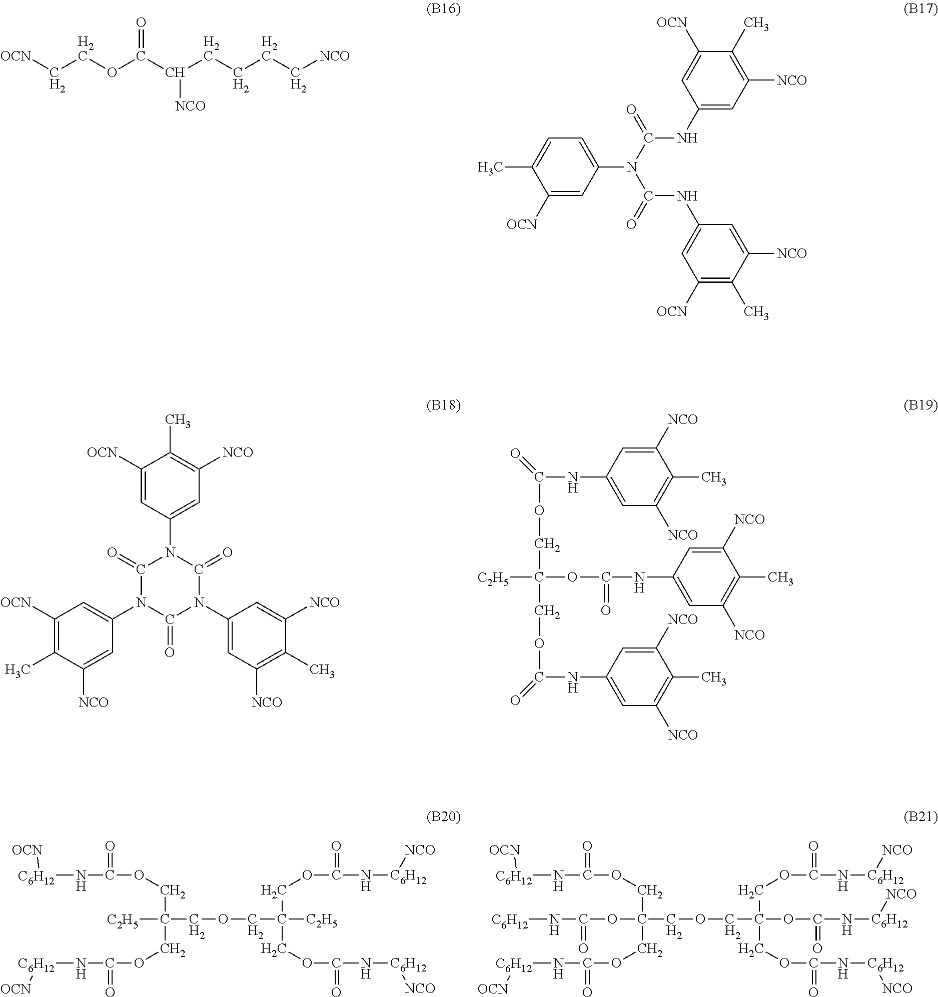

Amine compounds can have several (2 or more) N-methylol groups or alkyletherified N-methylol groups, for example. Examples of the amine compounds include melamine compounds, guanamine compounds and urea compounds. Examples of the amine compounds include compounds represented by one of Formulae (C1) to (C5) illustrated below or oligomers of compounds represented by one of Formulae (C1) to (C5) illustrated below.

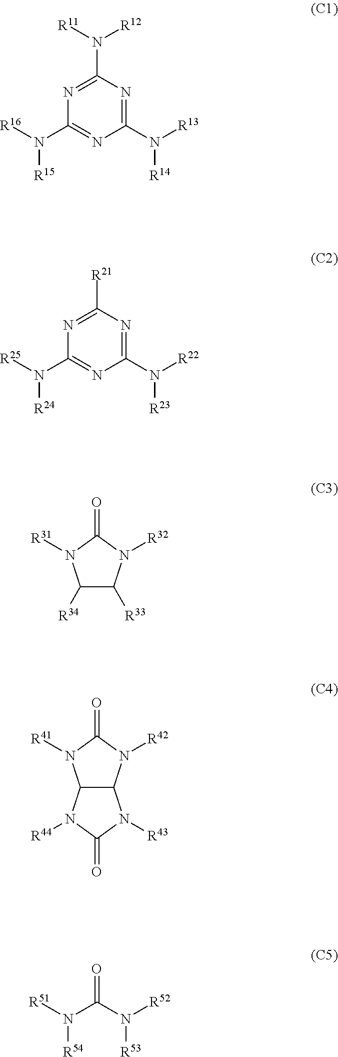

where R¹¹to R¹⁶, R²² to R²⁵, R³¹ to R³⁴, R⁴¹ to R⁴⁴ and R⁵¹ to R⁵⁴ each independently represent a hydrogen atom, a hydroxy group, an acyl group or a monovalent group represented by —CH₂—OR¹; at least one of R¹¹ to R¹⁶, at least one of R²² to R²⁵, at least one of R³¹ to R³⁴, at least one of R⁴¹ to R⁴⁴ and at least one of R⁵¹ to R⁵⁴ represent a monovalent group represented by —CH₂—OR¹; R¹ represents a hydrogen atom or an alkyl group having 1 or more and 10 or less carbon atoms where the alkyl group can be a methyl group, an ethyl group, a propyl group (n-propyl group, iso-propyl group), a butyl group (n-butyl group, iso-butyl group, tert-butyl group) or the like for polymerizability; and R²¹ represents an aryl group, an alkyl group-substituted aryl group, a cycloalkyl group or an alkyl group-substituted cycloalkyl group.

Specific examples of compounds represented by one of Formulae (C1) to (C5) will be illustrated below. Examples thereof may contain oligomers (multimers) of compounds represented by one of Formulae (C1) to (C5). The degree of polymerization of the multimers can be 2 or more and 100 or less. These multimers and monomers can be used as a mixture of two or more.

Examples of usually commercially available compounds represented by Formula (C1) include Supermelami No. 90 (manufactured by NOF Corporation), Super Beckamines (R) TD-139-60, L-105-60, L127-60, L110-60, J-820-60 and G-821-60 (manufactured by DIC Corporation), U-VAN 2020 (Mitsui Chemicals, Inc.), Sumitex Resin M-3 (Sumitomo Chemical Co., Ltd.), and Nikalacs MW-30, MW-390 and MX-750LM (manufactured by Nippon Carbide Industries Co., Inc.). Examples of usually commercially available compounds represented by Formula (C2) include Super Beckamines (R) L-148-55, 13-535, L-145-60 and TD-126 (manufactured by DIC Corporation), and Nikalacs BL-60 and BX-4000 (manufactured by Nippon Carbide Industries Co., Inc.). Examples of usually commercially available compounds represented by Formula (C3) include Nikalac MX-280 (manufactured by Nippon Carbide Industries Co., Inc.). Examples of usually commercially available compounds represented by Formula (C4) include Nikalac MX-270 (manufactured by Nippon Carbide Industries Co., Inc.). Examples of usually commercially available compounds represented by Formula (C5) include Nikalac MX-290 (manufactured by Nippon Carbide Industries Co., Inc.).

Specific examples of compounds represented by Formula (C1) will be illustrated below as compounds (C1-1) to (C1-12):

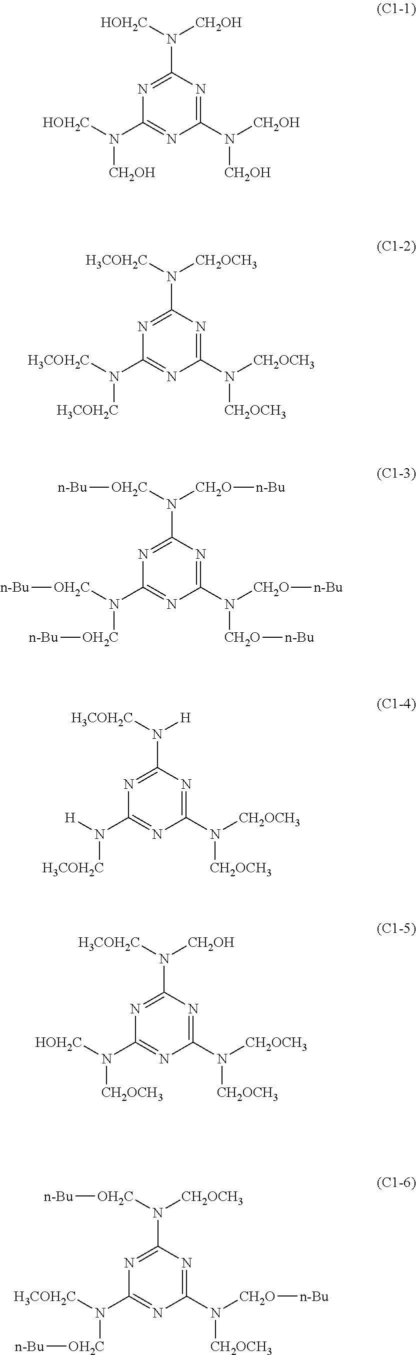

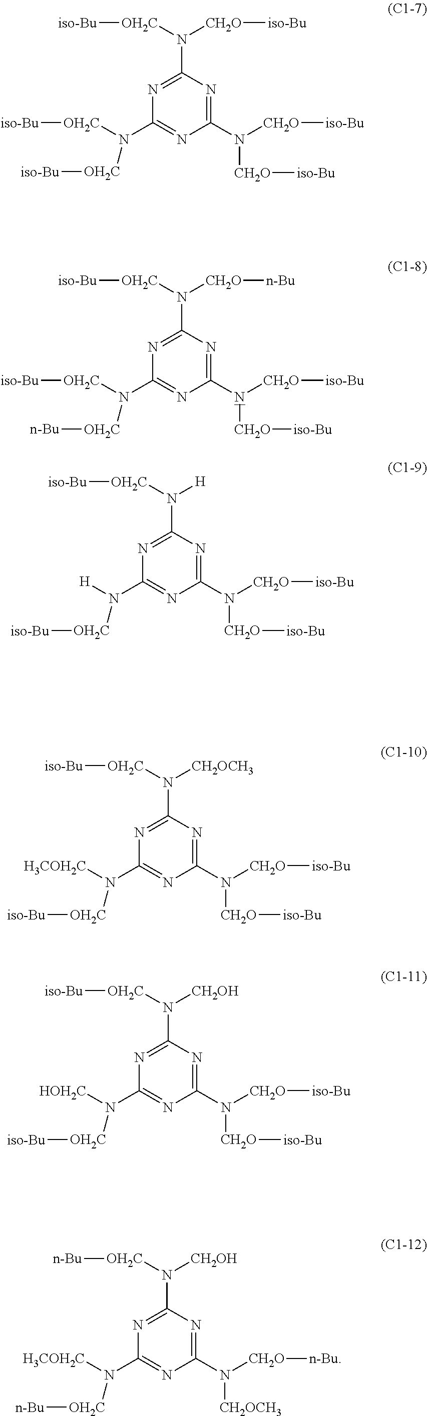

Specific examples of compounds represented by Formula (C2) will be illustrated below as compounds (C2-1) to (C2-18):

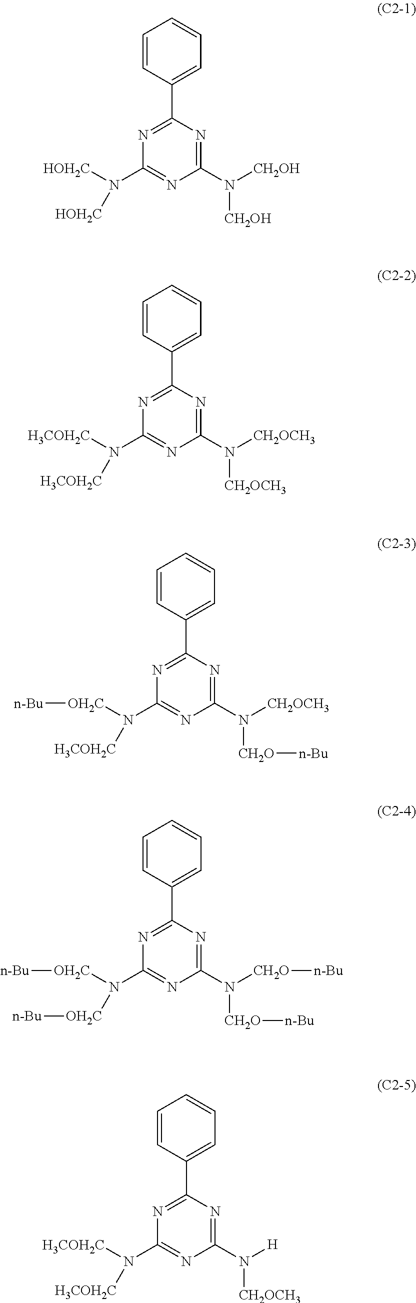

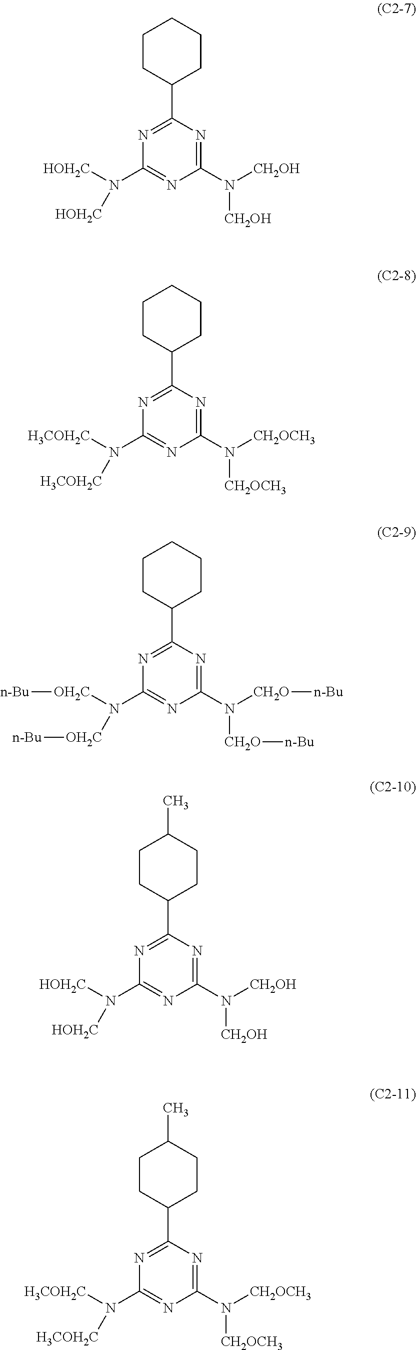

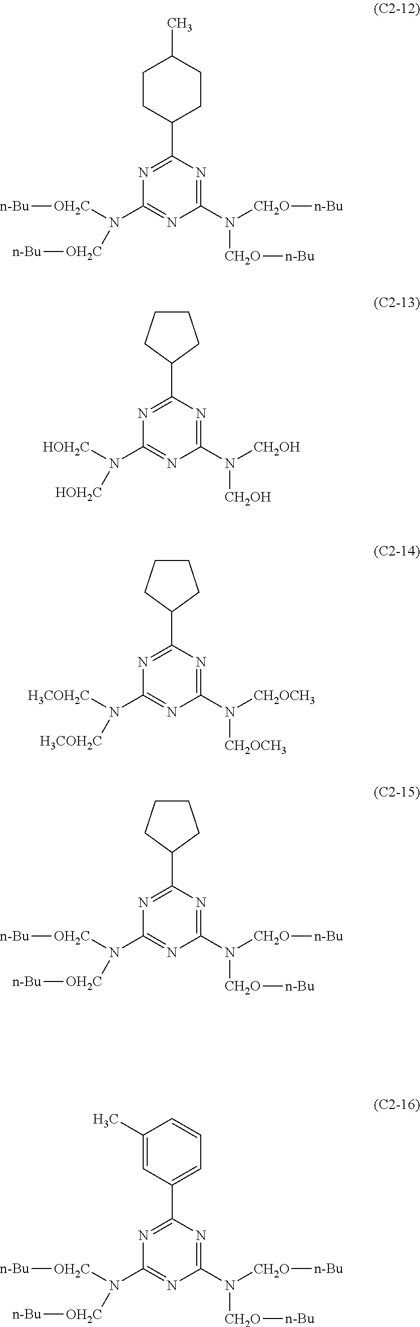

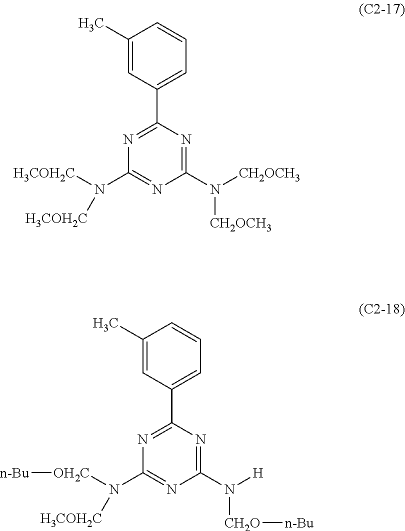

Specific examples of compounds represented by Formula (C3) will be illustrated below as compounds (C3-1) to (C3-6):

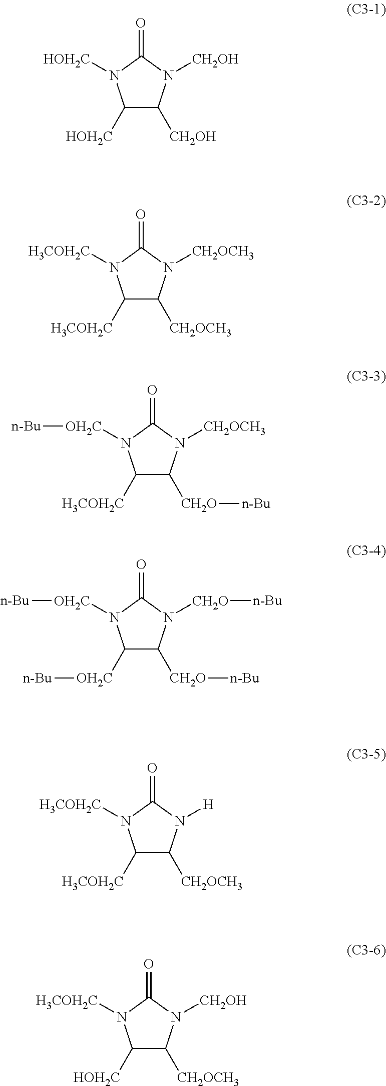

Specific examples of compounds represented by Formula (C4) will be illustrated below as compounds (C4-1) to (C4-6):

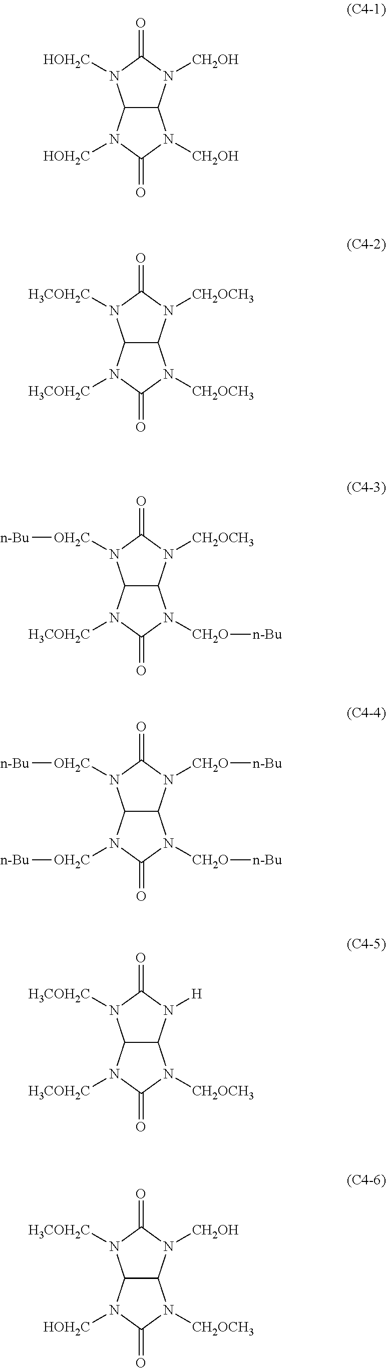

Specific examples of compounds represented by Formula (C5) will be illustrated below as compounds (C5-1) to (C5-6):

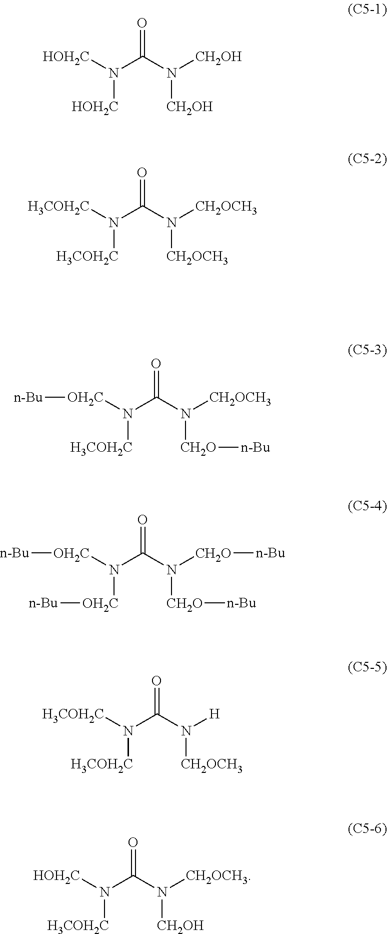

Next, a thermoplastic resin having a polymerizable functional group will be described. The thermoplastic resin having a polymerizable functional group can have a structural unit represented by Formula (D) illustrated below:

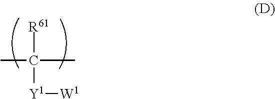

where R⁶¹ represents a hydrogen atom or an alkyl group; Y¹ represents a single bond, an alkylene group or a phenylene group; and W¹ represents a hydroxy group, a thiol group, an amino group, a carboxyl group or a methoxy group.

Examples of the thermoplastic resin having a structural unit represented by Formula (D) include acetal resins, polyolefin resins, polyester resins, polyether resins, polyamide resins and cellulose resins. The distinctive structures of these resins will be illustrated below. The thermoplastic resin may have the structural unit represented by Formula (D) in the distinctive structures illustrated below or in any place other than in the distinctive structures. The distinctive structures (E-1) to (E-5) are illustrated below. Acetal resin has a structural unit (E-1). Polyolefin resin has a structural unit (E-2). Polyester resin has a structural unit (E-3). Polyether resin has a structural unit (E-4). Polyamide resin has a structural unit (E-5). Cellulose resin has a structural unit (E-6).

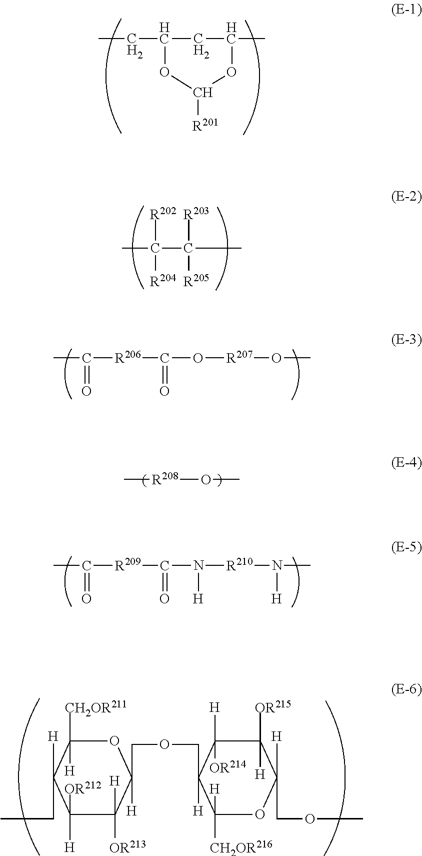

where R²⁰¹ to R²⁰⁵ each independently represent a substituted or unsubstituted alkyl group or a substituted or unsubstituted aryl group; R²⁰⁶ to R²¹⁰ each independently represent a substituted or unsubstituted alkylene group or a substituted or unsubstituted arylene group; when R²⁰¹ is C₃H₇, the distinctive structure is butyral; and R²¹¹ to R²¹⁶ represent an acetyl group, a hydroxyethyl group, a hydroxypropyl group or a hydrogen atom.

The resin having a structural unit represented by Formula (D) (hereinafter also referred to as “Resin D”) can be prepared by polymerization of a monomer having a polymerizable functional group (a hydroxy group, a thiol group, an amino group, a carboxyl group or a methoxy group) available from Sigma-Aldrich Japan K.K. or Tokyo Chemical Industry Co., Ltd.

Resin D is also usually commercially available. Examples of such commercially available resins include polyether polyol resins such as AQD-457 and AQD-473 manufactured by Nippon Polyurethane Industry Co., Ltd. and SUNNIXs GP-400 and GP-700 manufactured by Sanyo Chemical Industries, Ltd.; polyester polyol resins such as Phthalkyd W2343 manufactured by Hitachi Chemical Co., Ltd., Watersols S-118 and CD-520 and BECKOLITEs M-6402-50 and M-6201-40 IM manufactured by DIC Corporation, HARIDIP WH-1188 manufactured by Harima Chemicals Group, Inc., and ES3604 and ES6538 manufactured by Japan U-pica, Co., Ltd.; polyacrylic polyol resins such as BURNOCKs WE-300 and WE-304 manufactured by DIC Corporation; polyvinyl alcohol resins such as Kuraray POVAL PVA-203 manufactured by Kuraray Co., Ltd.; polyvinyl acetal resins such as BX-1 and BM-1 manufactured by Sekisui Chemical Co., Ltd.; polyamide resins such as TORESIN FS-350 manufactured by Nagase ChemteX Corporation; carboxyl group-containing resins such as AQUALIC manufactured by NIPPON SHOKUBAI CO., LTD. and FINELEX SG2000 manufactured by Namariichi Co., Ltd.; polyamine resins such as LUCKAMIDE manufactured by DIC Corporation; and polythiol resins such as QE-340M manufactured by Toray Industries, Inc. Among these, polyvinyl acetal resins and polyester polyol resins can be used from the viewpoint of polymerizability and the uniformity of the electron transporting layer.

Resin D can have a weight average molecular weight (Mw) of 5000 to 400000.

Examples of a method of determining the polymerizable functional group in the resin include titration of a carboxyl group with potassium hydroxide, titration of an amino group with sodium nitrite, titration of a hydroxyl group with acetic anhydride and potassium hydroxide, and titration of a thiol group with 5,5′-dithiobis(2-nitrobenzoic acid). Examples thereof also include a calibration curve method from IR spectra of samples having different ratios of a polymerizable functional group to be introduced.

Specific examples of Resin D are shown in Table below. In Table 12, Column “Distinctive structure” indicates a structural unit represented by one of (E-1) to (E-6).

TABLE 12

| | | | | Molar | | | |
|---|---|---|---|---|---|---|---|
| | | | | number of | | | |
| | Structure | | | functional | Distinctive | Substituent in distinctive | Molecular |
| | R⁶¹ | Y¹ | W¹ | group/g | structure | structure | weight |
| D1 | H | Single bond | OH | 3.3 mmol | Butyral | R²⁰¹ = C₃H₇ | 1 × 10⁵ |
| D2 | H | Single bond | OH | 3.3 mmol | Butyral | R²⁰¹ = C₃H₇ | 4 × 10⁴ |
| D3 | H | Single bond | OH | 3.3 mmol | Butyral | R²⁰¹ = C₃H₇ | 2 × 10⁴ |
| D4 | H | Single bond | OH | 1.0 mmol | Polyolefin | R²⁰² to R²⁰⁵ = H | 1 × 10⁵ |
| D5 | H | Single bond | OH | 3.0 mmol | Polyester | R²⁰⁶ = R²⁰⁷ = C₂H₄ | 8 × 10⁴ |
| D6 | H | Single bond | OH | 2.5 mmol | Polyether | R²⁰⁸ = C₄H₈ | 5 × 10⁴ |
| D7 | H | Single bond | OH | 2.1 mmol | Polyether | R²⁰⁸ = C₄H₈ | 2 × 10⁵ |
| D8 | H | Single bond | COOH | 3.5 mmol | Polyolefin | R²⁰² to R²⁰⁵ = H | 6 × 10⁴ |
| D9 | H | Single bond | NH₂ | 1.2 mmol | Polyamide | R²⁰⁹ = C₁₀H₂₀, R²¹⁰ = C₆H₁₂ | 2 × 10⁵ |
| D10 | H | Single bond | SH | 1.3 mmol | Polyolefin | R²⁰² to R²⁰⁵ = H | 9 × 10³ |
| D11 | H | Phenylene | OH | 2.8 mmol | Polyolefin | R²⁰² to R²⁰⁵ = H | 4 × 10³ |
| D12 | H | Single bond | OH | 3.0 mmol | Butyral | R²⁰¹ = C₃H₇ | 7 × 10⁴ |
| D13 | H | Single bond | OH | 2.9 mmol | Polyester | R²⁰⁶ = Ph, R²⁰⁷ = C₂H₄ | 2 × 10⁴ |
| D14 | H | Single bond | OH | 2.5 mmol | Polyester | R²⁰⁶ = R²⁰⁷ = C₂H₄ | 6 × 10³ |
| D15 | H | Single bond | OH | 2.7 mmol | Polyester | R²⁰⁶ = R²⁰⁷ = C₂H₄ | 8 × 10⁴ |
| D16 | H | Single bond | COOH | 1.4 mmol | Polyolefin | R²⁰² to R²⁰⁴ = H, R²⁰⁵ = CH₃ | 2 × 10⁵ |
| D17 | H | Single bond | COOH | 2.2 mmol | Polyester | R²⁰⁶ = Ph, R²⁰⁷ = C₂H₄ | 9 × 10³ |
| D18 | H | Single bond | COOH | 2.8 mmol | Polyester | R²⁰⁶ = R²⁰⁷ = C₂H₄ | 8 × 10² |
| D19 | CH₃ | CH₂ | OH | 1.5 mmol | Polyester | R²⁰⁶ = R²⁰⁷ = C₂H₄ | 2 × 10⁴ |
| D20 | C₂H₅ | CH₂ | OH | 2.1 mmol | Polyester | R²⁰⁶ = R²⁰⁷ = C₂H₄ | 1 × 10⁴ |
| D21 | C₂H₅ | CH₂ | OH | 3.0 mmol | Polyester | R²⁰⁶ = R²⁰⁷ = C₂H₄ | 5 × 10⁴ |
| D22 | H | Single bond | OCH₃ | 2.8 mmol | Polyolefin | R²⁰² to R²⁰⁵ = H | 7 × 10³ |
| D23 | H | Single bond | OH | 3.3 mmol | Butyral | R²⁰¹ = C₃H₇ | 2.7 × 10⁵ |
| D24 | H | Single bond | OH | 3.3 mmol | Butyral | R²⁰¹ = C₃H₇ | 4 × 10⁵ |
| D25 | H | Single bond | OH | 2.5 mmol | Acetal | R²⁰¹ = H | 3.4 × 10⁵ |
| D26 | H | Single bond | OH | 2.8 mmol | Cellulose | R²¹¹ = R²¹⁶ = COCH3, R²¹² to | 3 × 10⁴ |
| | | | | | | R²¹⁵ = H | |

The second intermediate layer has a thickness of preferably 0.1 μm or more and 1.5 μm or less, more preferably 0.2 μm or more and 0.7 μm or less.

If the thickness of the second intermediate layer is ⅙ to 2 times the thickness of the first intermediate layer, the effect of reducing environmental fluctuations is higher and the residual potential is reduced more significantly. If the thickness of the second intermediate layer is ⅙ times or more the thickness of the first intermediate layer, a change in the resistance of the first intermediate layer is relatively reduced compared to the amount of movable photocarriers (electrons) generated in the charge generating layer. Probably for this reason, the effect of reducing environmental fluctuations is enhanced more significantly. If the thickness of the second intermediate layer is 2 times or less the thickness of the first intermediate layer, the amount of movable charges in the first intermediate layer is relatively increased compared to the amount of the movement of the charges in the second intermediate layer. Probably for this reason, the residual potential is reduced more significantly.

The content of the electron transporting substance having a polymerizable functional group is 25% by mass or more based on the total mass of the composition. At a content of less than 25% by mass, the amount of movable charges in the second intermediate layer is relatively insufficient to the photocarriers (electrons) generated in the charge generating layer, leading to poor sensitivity and high residual potential in any environment. The composition includes an electron transporting substance having a polymerizable functional group and a crosslinking agent, or an electron transporting substance having a polymerizable functional group, a crosslinking agent and a thermoplastic resin having a polymerizable functional group.

The content of the electron transporting substance having a polymerizable functional group can be 30% by mass or more and 70% by mass or less based on the total mass of the composition of the second intermediate layer. At a content of 30% by mass or more and 70% by mass or less, the sensitivity is high and the residual potential is reduced more significantly in any environment. At a content of 30% by mass or more, the amount of movable charges in the second intermediate layer is relatively increased compared to the photocarriers (electrons) generated in the charge generating layer, leading to higher sensitivity and reduced residual potential in any environment. At a content of 70% by mass or less, it seems that the electron transporting substance is polymerized to promote formation of a three-dimensional net structure, more significantly enhancing the effect of reducing environmental fluctuations and generation of leakage.

The content of the electron transporting substance based on the total mass of the composition of the second intermediate layer can be ⅓ to 1 time the content of the titanium oxide particle based on the total mass of the first intermediate layer.

If the content of the electron transporting substance based on the total mass of the composition of the second intermediate layer is ⅓ to 1 time the content of the titanium oxide particle based on the total mass of the first intermediate layer, the effect of reducing environmental fluctuations is enhanced more significantly and the residual potential is reduced more significantly.

If the content of the electron transporting substance based on the total mass of the composition of the second intermediate layer is ⅓ times or more the content of the titanium oxide particle based on the total mass of the first intermediate layer, the amount of movable charges in the second intermediate layer is relatively increased compared to the photocarriers (electrons) generated in the charge generating layer. The present inventors think that for this reason, the effect of reducing environmental fluctuations is enhanced more significantly. If the content of the electron transporting substance based on the total mass of the composition of the second intermediate layer is 1 time or less the content of the titanium oxide particle based on the total mass of the first intermediate layer, the amount of movable charges in the first intermediate layer is relatively increased compared to the amount of the movement of the charges in the second intermediate layer. The present inventors think that for this reason, the residual potential is reduced more significantly.

[Charge Generating Layer]

A charge generating layer is provided directly on the second intermediate layer.

Examples of the charge generating substance used in the charge generating layer include azo pigments, perylene pigments, anthraquinone derivatives, anthanthrone derivatives, dibenzpyrenequinone derivatives, pyranthrone derivatives, violanthrone derivatives, isoviolanthrone derivatives, indigo derivatives, thioindigo derivatives, phthalocyanine pigments such as metal phthalocyanine and non-metal phthalocyanine, and bisbenzimidazole derivatives. Among these, at least one of azo pigments and phthalocyanine pigments can be used. Among these phthalocyanine pigments, oxytitanium phthalocyanine, chlorogallium phthalocyanine and hydroxy gallium phthalocyanine can be used.

Oxytitanium phthalocyanines can be oxytitanium phthalocyanine crystals having peaks at Bragg angles (2θ±0.2°) of 9.0°, 14.2°, 23.9° and 27.1° in CuKα characteristics X ray diffraction and oxytitanium phthalocyanine crystals having peaks at Bragg angles (2θ±0.2°) of 9.5°, 9.7°, 11.7°, 15.0°, 23.5°, 24.1° and 27.3°.

Chlorogallium phthalocyanines can be chlorogallium phthalocyanine crystals having peaks at Bragg angles (2θ±0.2°) of 7.4°, 16.6°, 25.5° and 28.2° in CuKα characteristics X ray diffraction, chlorogallium phthalocyanine crystals having peaks at Bragg angles (2θ±0.2°) of 6.8°, 17.3°, 23.6° and 26.9°, and chlorogallium phthalocyanine crystals having peaks at Bragg angles (2θ±0.2°) of 8.7°, 9.2°, 17.6°, 24.0°, 27.4° and 28.8°.

Hydroxy gallium phthalocyanines can be hydroxy gallium phthalocyanine crystals having peaks at Bragg angles 2θ±0.2°) of 7.3°, 24.9° and 28.1° in CuKα characteristics X ray diffraction, and hydroxy gallium phthalocyanine crystals having peaks at Bragg angles 2θ±0.2°) of 7.5°, 9.9°, 12.5°, 16.3°, 18.6°, 25.1° and 28.3°.

Examples of the binder resin used in the charge generating layer include polymers and copolymers of vinyl compounds such as styrene, vinyl acetate, vinyl chloride, acrylic acid ester, methacrylic acid ester, vinylidene fluoride and trifluoroethylene; polyvinyl alcohol resins; polyvinyl acetal resins; polycarbonate resins; polyester resins; polysulfone resins; polyphenylene oxide resins; polyurethane resins; cellulose resins; phenol resins; melamine resins; silicon resins; and epoxy resins. Among these, polyester resins, polycarbonate resins and polyvinyl acetal resins are preferred, and polyvinyl acetal is more preferred.

In the charge generating layer, the ratio of the charge generating substance to the binder resin (charge generating substance/binder resin) is preferably 10/1 to 1/10, more preferably 5/1 to 1/5. Examples of a solvent used in the coating solution for a charge generating layer include alcohol solvents, sulfoxide solvents, ketone solvents, ether solvents, ester solvents or aromatic hydrocarbon solvents.

The thickness of the charge generating layer can be 0.05 μm or more and 5 μm or less.

[Hole Transporting Layer]

A hole transporting layer is formed on the charge generating layer.

Examples of the hole transport substance used in the hole transporting layer include polycyclic aromatic compounds, heterocycle compounds, hydrazone compounds, styryl compounds, benzidine compounds, triarylamine compounds and triphenylamine. Examples thereof include polymers having groups derived from these compounds in the main chain or the side chain. Among these, triarylamine compounds, benzidine compounds or styryl compounds can be used.

Examples of the binder resin used in the hole transporting layer include polyester resins, polycarbonate resins, polymethacrylic acid ester resins, polyarylate resins, polysulfone resins and polystyrene resins. Among these, polycarbonate resins and polyarylate resins can be used. These resins can have weight average molecular weights (Mw)=10,000 to 300,000.

In the hole transporting layer, the ratio of the hole transport substance to the binder resin (hole transport substance/binder resin) is preferably 10/5 to 5/10, more preferably 10/8 to 6/10.

The hole transporting layer has a thickness of preferably 3 μm or more and 40 μm or less, more preferably 5 μm or more and 16 μm or less. Examples of the solvent used in the coating solution for a hole transporting layer include alcohol solvents, sulfoxide solvents, ketone solvents, ether solvents, ester solvents or aromatic hydrocarbon solvents.

A surface protective layer may be formed on the hole transporting layer. The surface protective layer contains a conductive particle or a charge transporting substance and a binder resin. The surface protective layer may further contain additives such as lubricants. Alternatively, the binder resin in the protective layer may have conductivity or charge transportability. In this case, no conductive particle or charge transporting substance in addition to the resin needs to be contained in the protective layer. The binder resin in the protective layer may be a thermoplastic resin, or may be a curable resin polymerized by heat, light or radiation (such as electron beams).

In a preferred method of forming layers forming the electrophotographic photosensitive member such as the first intermediate layer, the second intermediate layer, the charge generating layer and the hole transporting layer, first, a material for each layer is dissolved and/or dispersed in a solvent to prepare a coating solution, and the resulting coating solution is applied to form a coating. Next, the resulting coating is dried and/or cured. Examples of the method of applying a coating solution include immersion coating, spray coating, curtain coating and spin coating. Among these, immersion coating can be used from the viewpoint of efficiency and productivity.

[Process Cartridge and Electrophotographic Apparatus]

FIGURE illustrates a schematic configuration of an electrophotographic apparatus including a process cartridge provided with the electrophotographic photosensitive member.

In FIGURE, a cylindrical electrophotographic photosensitive member 1 is driven by rotation about an axis 2 in the arrow direction at a predetermined circumferential speed. The surface (circumferential surface) of the electrophotographic photosensitive member 1 driven by rotation is uniformly charged by a charging unit 3 (primary charging unit such as a charging roller) to have a predetermined positive or negative potential. Next, the surface of the electrophotographic photosensitive member 1 receives exposing light 4 (image exposing light) from an exposing unit (not illustrated) by slit exposure, laser beam scanning exposure or the like. An electrostatic latent image is sequentially formed on the surface of the electrophotographic photosensitive member 1 in correspondence with the target image.

The electrostatic latent image formed on the surface of the electrophotographic photosensitive member 1 is developed by a toner contained in a developer in a developing unit 5 to form a toner image. Next, the toner image formed and carried on the surface of the electrophotographic photosensitive member 1 is sequentially transferred onto a transfer material P (such as paper) by transfer bias from a transfer unit 6 (such as a transfer roller). The transfer material P is extracted from a transfer material feeding unit (not illustrated) in synchronization with the rotation of the electrophotographic photosensitive member 1, and is fed into a contact region between the electrophotographic photosensitive member 1 and the transfer unit 6.

The transfer material P having a transferred toner image is separated from the surface of the electrophotographic photosensitive member 1, and is introduced into a fixing unit 8 to fix the image. Thereby, an image formed product (such as printed matters and copy) is printed out from the apparatus.

After transfer of the toner image, the surface of the electrophotographic photosensitive member 1 is cleaned by removing a transfer residual developer (toner) with a cleaning unit 7 (such as a cleaning blade). Next, the surface of the electrophotographic photosensitive member 1 is discharged by pre-exposing light 11 from a pre-exposing unit (not illustrated), and is repeatedly used in image formation. As illustrated in FIGURE, pre-exposure is not always necessary when the charging unit 3 is a contact charging unit provided with a charging roller.

Several components selected from the electrophotographic photosensitive member 1, the charging unit 3, the developing unit 5, the transfer unit 6 and the cleaning unit 7 may be accommodated in a container to be integrally formed as a process cartridge, and the process cartridge may be configured attachable to and detachable from the main body of an electrophotographic apparatus such as copiers and laser beam printers. In FIGURE, the electrophotographic photosensitive member 1, the charging unit 3, the developing unit 5 and the cleaning unit 7 are integrally supported to form a process cartridge 9, which is attachable to and detachable from the main body of an electrophotographic apparatus with a guiding unit 10 such as a rail provided with the main body of the electrophotographic apparatus.

### EXAMPLES

The present invention will now be described in more detail by way of specific Examples. The present invention will not be limited to these. The term “parts” indicates “parts by mass.”

### Synthesis Example

Under room temperature, 1,4,5,8-naphthalenetetracarboxylic dianhydride (26.8 g, 100 mmol) and dimethylacetamide (150 ml) were placed in a 300 ml three-necked flask under a nitrogen stream. A mixture of butanolamine (8.9 g, 100 mmol) and dimethylacetamide (25 ml) was added dropwise to the solution under stirring. After dropping was completed, the solution was heated under reflux for 6 hours. After the reaction was completed, the container was cooled to condense the solution under reduced pressure. Ethyl acetate was added to the residue, and the residue was refined by silica gel column chromatography. The recovered product was further recrystallized with ethyl acetate/hexane to prepare a monoimide product (10.2 g) having a butanol structure introduced into one side of the product.

The monoimide product (6.8 g, 20 mmol), hydrazine monohydrate (1 g, 20 mmol), p-toluenesulfonic acid (10 mg) and toluene (50 ml) were placed in a 300 ml three-necked flask, and the solution was heated under reflux for 5 hours. After the reaction was completed, the container was cooled to condense the solution under reduced pressure. The residue was refined by silica gel column chromatography. The recovered product was further recrystallized with toluene/ethyl acetate to prepare an electron transporting substance (2.54 g) represented by Formula (A1101).

Next, production and evaluation of the electrophotographic photosensitive member will be described.

—Preparation of Coating Solution for First Intermediate Layer 1—

A polyamide resin (trade name: TORESIN F-30K, manufactured by Nagase ChemteX Corporation) (10 parts) was dissolved in methanol (50 parts) and n-propanol (50 parts). A titanium oxide particle (trade name: TTO-55N, manufactured by Ishihara Sangyo Kaisha, Ltd., average particle size: 40 nm) (30 parts) was mixed with the dissolution solution. The solution was dispersed for 3 hours in a sand mill using glass beads having a diameter of mm to prepare Coating solution for first intermediate layer 1.

—Preparation of Coating Solution for First Intermediate Layer 2—

Coating solution for first intermediate layer 2 was prepared in the same manner except that the titanium oxide particle (trade name: TTO-55N) used in Preparation of Coating solution for first intermediate layer 1 was replaced with a titanium oxide particle (trade name: CR-EL, manufactured by Ishihara Sangyo Kaisha, Ltd., average particle size: 260 nm).

—Preparation of Coating Solution for First Intermediate Layer 3—

A titanium oxide particle (trade name: TTO-55N) (80 parts), an alkyd resin (trade name: BECKOLITE M-6401-50, solid content: 50 wt %, manufactured by DIC Corporation) (28 parts) and a melamine resin (trade name: SUPER BECKAMINE G-821-60, solid content: 60 wt %, manufactured by DIC Corporation) (10 parts) and 2-butanone (50 parts) were mixed. The mixture was dispersed for 3 hours in a sand mill using glass beads having a diameter of 1 mm to prepare Coating solution for first intermediate layer 3.

—Preparation of Coating Solution for First Intermediate Layer 4—

Coating solution for first intermediate layer 4 was prepared in the same manner except that the titanium oxide particle (trade name: TTO-55N) used in Preparation of Coating solution for first intermediate layer 3 was replaced with a titanium oxide particle (trade name: CR-EL, manufactured by Ishihara Sangyo Kaisha, Ltd., average particle size: 260 nm).

—Preparation of Coating Solution for First Intermediate Layer 5—

Coating solution for first intermediate layer 5 was prepared in the same manner except that the melamine resin used in Preparation of Coating solution for first intermediate layer 4 was replaced with block isocyanate (trade name: BURNOCK DB-980K, solid content: 75 wt %, manufactured by DIC Corporation) (30 parts).

—Preparation of Coating Solution for First Intermediate Layer 6—

Coating solution for first intermediate layer 6 was prepared in the same manner except that the polyamide resin used in Preparation of Coating solution for first intermediate layer 1 was replaced with a resin having a structural unit represented by Formula (1) and produced by the method described in Japanese Patent Application Laid-Open No. H04-31870.

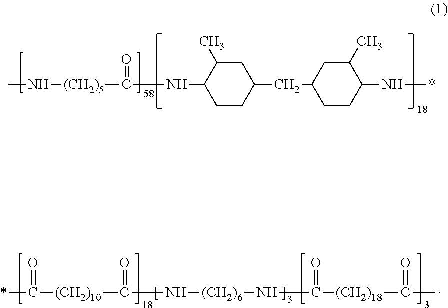

—Preparation of Coating Solutions for First Intermediate Layer 7 to 10—

The amount of the titanium oxide particle used in Preparation of Coating solution for first intermediate layer 6 was changed from 30 parts to 10 parts (Coating solution for first intermediate layer 7), 14 parts (Coating solution for first intermediate layer 8), 20 parts (Coating solution for first intermediate layer 9) and 70 parts (Coating solution for first intermediate layer 10). Except for these, Coating solutions for first intermediate layer 7 to 10 were prepared in the same manner.

—Preparation of Coating Solution for First Intermediate Layer 11—

Coating solution for first intermediate layer 11 was prepared in the same manner except that the amount of the titanium oxide particle used in Preparation of Coating solution for first intermediate layer 6 was changed form 30 parts to 100 parts and the amount of the polyamide resin was changed from 10 parts to 5 parts.

—Preparation of Coating Solution for First Intermediate Layer 12—

Coating solution for first intermediate layer 12 was prepared in the same manner except that the titanium oxide particle (trade name: TTO-55N) used in Coating solution for first intermediate layer 6 was replaced with a titanium oxide particle (trade name: TITANIX-JR, manufactured by Tayca Corporation, average particle size: 270 nm).

—Preparation of Coating Solution for First Intermediate Layer 13—

The polyamide resin represented by Formula (1) (10 parts) was dissolved in methanol (50 parts) and n-propanol (50 parts). A surface-treated titanium oxide particle (30 parts) (titanium oxide particle used in Example 3 in Japanese Patent Application Laid-Open No. 2012-88430) was mixed with the dissolution solution. The solution was dispersed for 3 hours in a sand mill using glass beads having a diameter of 1 mm to prepare Coating solution for first intermediate layer 13.

### Example 1

An aluminum cylinder (JIS-A3003, aluminum alloy) having a diameter of 30 mm was used as a support (conductive support).

Next, Coating solution for first intermediate layer 1 was applied onto the support by immersion coating to form a coating. The resulting coating was dried for 10 minutes at 100° C. to form a first intermediate layer having a thickness of 1.5 μm.

Next, Electron transporting substance (A101) (4 parts), Crosslinking agent (B1:protecting group (H1)=5.1:2.2 (mass ratio)) (5.5 parts), Resin (D1) (in Formula (E-1), R²⁰¹ is C₃H₇) (0.3 parts) and dioctyltin laurate (0.05 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto the first intermediate layer by immersion coating to form a coating. The resulting coating was heated for 40 minutes at 160° C. to be polymerized to form a second intermediate layer having a thickness of 0.52 μm.

The content of the electron transporting substance was 41% by mass based on the total mass of the composition. The thickness of the second intermediate layer was 0.35 times the thickness of the first intermediate layer. The content of the electron transporting substance based on the total mass of the composition of the second intermediate layer was 0.55 times the content of the titanium oxide particle based on the total mass of the first intermediate layer.

Next, a hydroxy gallium phthalocyanine crystal (charge generating substance) having peaks at Bragg angles 2θ±0.2°) of 7.5°, 9.9°, 12.5°, 16.3°, 18.6°, 25.1° and 28.3° in CuKα characteristics X ray diffraction was prepared. The hydroxy gallium phthalocyanine crystal (10 parts), a compound represented by Formula (17) (0.1 parts), polyvinyl butyral (trade name: S-LEC BX-1, manufactured by Sekisui Chemical Co., Ltd.) (5 parts) and cyclohexanone (250 parts) were placed in a sand mill with glass beads having a diameter of 0.8 mm, and were dispersed for 1.5 hours. Next, ethyl acetate (250 parts) was added to the solution to prepare a coating solution for a charge generating layer.

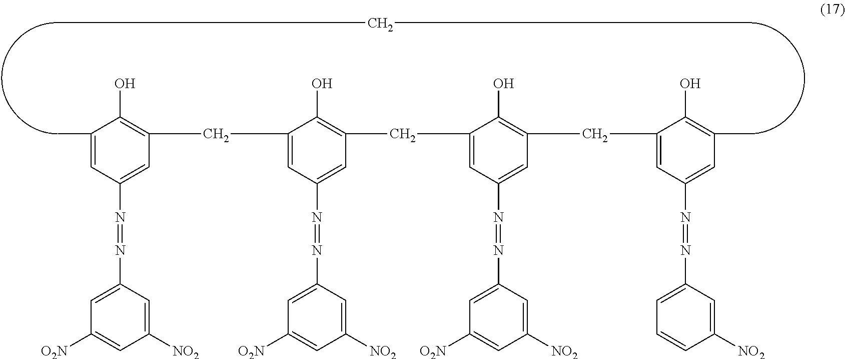

The coating solution for a charge generating layer was applied onto the second intermediate layer by immersion coating. The resulting coating was dried for 10 minutes at 100° C. to form a charge generating layer having a thickness of 0.15 μm.

Next, a triarylamine compound represented by Formula (9-1) (4 parts), a benzidine compound represented by Formula (9-2) (4 parts) and bisphenol Z polycarbonate (trade name: 2400, manufactured by Mitsubishi Engineering-Plastics Corporation) (10 parts) were dissolved in a mixed solvent of dimethoxymethane (40 parts) and chlorobenzene (60 parts) to prepare a coating solution for a hole transporting layer. The coating solution for a hole transporting layer was applied onto the charge generating layer by immersion coating. The resulting coating was dried for 40 minutes at 120° C. to form a hole transporting layer having a thickness of 15 μm.

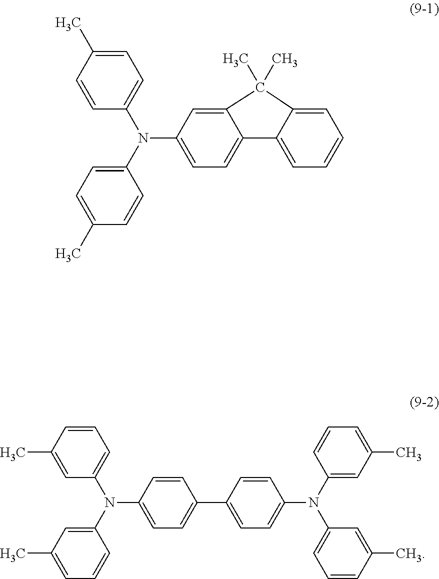 [SMILES: Cc1ccc(N(c2ccc(C)cc2)c2ccc3c(c2)C(C)(C)c2ccccc2-3)cc1 ; Cc1cccc(N(c2ccc(-c3ccc(N(c4cccc(C)c4)c4cccc(C)c4)cc3)cc2)c2cccc(C)c2)c1]

The electrophotographic photosensitive member thus prepared was evaluated under an environment of low temperature and low humidity (15° C./10% RH) for bright potential, residual potential and leakage and under an environment of high temperature and high humidity (30° C./80% RH) for bright potential.

The evaluations on bright potential, residual potential and leakage were performed with a modified laser beam printer manufactured by Canon Inc. (trade name: LBP-2510) such that the amount of exposing light was variable.

(Evaluations on Bright Potential and Residual Potential)

In the evaluation on potential under a low temperature and low humidity environment, an apparatus and a drum cartridge were left for 48 hours under an environment of temperature of 15° C./humidity of 10% RH.

The surface potential of the electrophotographic photosensitive member was measured by extracting a developing cartridge from an evaluation machine and installing a potential measurement apparatus instead of the developing cartridge. The potential measurement apparatus was provided with a probe for measuring potential at a developing position of the developing cartridge. The probe for measuring potential was located at the center of the electrophotographic photosensitive member in the drum axis direction.

The surface of the electrophotographic photosensitive member was charged such that the dark potential (Vd) was −700 V. The bright potential (Vl) at an amount of light of 0.3 μJ/cm² was measured at the developing position, and was defined as a bright potential. The surface of the electrophotographic photosensitive member was also charged such that the dark potential (Vd) was −700 V. The bright potential (Vl) at an amount of light of 2.0 μJ/cm² was measured at the developing position, and was defined as a residual potential (Vr (V)).

The bright potential under a high temperature and high humidity environment was evaluated in the same manner as under a low temperature and low humidity environment. The residual potential was 18 V. The difference (ΔVl (V)) between the bright potential under low temperature and low humidity and that under high temperature and high humidity was 11 V.

(Evaluation on Leakage)

The electrophotographic photosensitive member produced above was mounted on the laser beam printer manufactured by Canon Inc. The printer was placed under a low temperature and low humidity (15° C./10% RH) environment to perform a durability test in which an image having a pattern of vertical lines with 3 dots and 100 spaces was repeatedly and continuously output onto 15000 sheets while a toner was fed. After the image was output onto 15000 sheets, one sheet of a sample for image evaluation (halftone image with a one-dot KEIMA pattern) was output.

The image was evaluated on the following criteria:
A: no image failures caused by generation of leakage are found in the image.
B: small black dots caused by generation of leakage are found in the image.
C: large black dots caused by generation of leakage are found in the image.
D: large black dots and short horizontal black stripes caused by generation of leakage are found in the image.
E: long horizontal black stripes caused by generation of leakage are found in the image.

The results are shown in Table 13. In Tables 13 and 14, the difference (ΔVl (V)) between the bright potential under low temperature and low humidity and that under high temperature and high humidity was shown as the evaluation of the environment potential.

### Examples 2 to 6

An electrophotographic photosensitive member was produced in the same manner as in Example 1 except that first intermediate layers were formed with coating solutions for a first intermediate layer as shown in Table 13, and was evaluated in the same manner. The results are shown in Table 13.

### Examples 7 to 28

Electrophotographic photosensitive members were produced in the same manner as in Example 6 except that the types of the electron transporting substance having a polymerizable functional group, the crosslinking agent and the thermoplastic resin having a polymerizable functional group and thickness of the second intermediate layer were changed as shown in Table 13, and were evaluated in the same manner. The results are shown in Table 13.

Resins D3, D5, D19 and D21 were used in Examples.
D3: in Formula (E-1), R²⁰¹ is C₃H₇.
D5: in Formula (E-4), R²⁰⁶ is (CH₂)₆, and R²⁰⁷ is CH₂C(CH₃)₂CH₂.
D18: in Formula (E-4), R²⁰⁶ is (CH₂)₆, and R²⁰⁷ is CH₂C (CH₃)₂CH₂.
D21: in Formula (E-4), R²⁰⁶ is (CH₂)₆, and R²⁰⁷ is CH₂C (CH₃)₂CH₂.

### Examples 29 to 48

Electrophotographic photosensitive members were produced in the same manner as in Example 4 except that the types of the electron transporting substance having a polymerizable functional group, the crosslinking agent and the thermoplastic resin having a polymerizable functional group and the thickness of the second intermediate layer were changed as shown in Table 13, and were evaluated in the same manner. The results are shown in Table 13.

### Example 49

An electrophotographic photosensitive member was produced in the same manner as in Example 29 except that the second intermediate layer was formed as follows, and was evaluated in the same manner. The results are shown in Table 13.

Electron transporting substance (A-101) (5.0 parts), Amine compound (C1-1) (1.75 parts), Resin (D1) (2.0 parts) and dodecylbenzenesulfonic acid (0.1 parts) as a catalyst were dissolved in a mixed solvent of dimethylacetamide (100 parts) and methyl ethyl ketone (100 parts) to prepare a coating solution for a second intermediate layer.

The coating solution for a second intermediate layer was applied onto the first intermediate layer by immersion coating. The resulting coating was dried for 40 minutes at 160° C. to be cured to form a second intermediate layer having a thickness of 0.68 μm. The content of the electron transporting substance was 57% by mass based on the total mass of the composition.

### Example 50

An electrophotographic photosensitive member was produced in the same manner as in Example 49 except that Amine compound (C1-1) used in the second intermediate layer was changed to (C1-3), and was evaluated in the same manner. The results are shown in Table 13.

### Example 51

An electrophotographic photosensitive member was produced in the same manner as in Example 29 except that the second intermediate layer was formed as follows, and was evaluated in the same manner. The results are shown in Table 13.

Electron transporting substance (A-101) (4 parts), Amine compound (C1-9) (4 parts), Resin (D1) (1.5 parts) and dodecylbenzenesulfonic acid (0.2 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto the first intermediate layer by immersion coating. The resulting coating was heated for 40 minutes at 170° C. to be polymerized to form a second intermediate layer having a thickness of 0.68 μm.

The content of the electron transporting substance was 42% by mass based on the total mass of the composition.

### Examples 52 and 53

An electrophotographic photosensitive member was prepared in the same manner as in Example 51 except that Crosslinking agent (C1-9) used in Example 51 was changed to the crosslinking agent shown in Table 13, and was evaluated in the same manner. The results are shown in Table 14.

### Example 54

An electrophotographic photosensitive member was produced in the same manner as in Example 6 except that a second intermediate layer was formed as follows, and was evaluated in the same manner. The results are shown in Table 14.

Electron transporting substance (A101) (3.2 parts), Isocyanate compound (B1:protecting group (H1)=5.1:2.2 (mass ratio)) (5.0 parts), Resin (D1) (4.2 parts) and dioctyltin laurate (0.05 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto the first intermediate layer by immersion coating to form a coating. The resulting coating was heated for 40 minutes at 160° C. to be polymerized to form a second intermediate layer having a thickness of 0.52 μm.

The content of the electron transporting substance was 25% by mass based on the total mass of the composition.

### Example 55

An electrophotographic photosensitive member was produced in the same manner as in Example 6 except that a second intermediate layer was formed as follows, and was evaluated in the same manner. The results are shown in Table 14.

Electron transporting substance (A101) (3.6 parts), Isocyanate compound (B1:protecting group (H1)=5.1:2.2 (mass ratio)) (7 parts), Resin (D1) (1.3 parts) and dioctyltin laurate (0.05 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto the first intermediate layer by immersion coating. The resulting coating was heated for 40 minutes at 170° C. to be polymerized to form a second intermediate layer having a thickness of 0.52 μm.

The content of the electron transporting substance was 30% by mass based on the total mass of the composition.

### Example 56

An electrophotographic photosensitive member was produced in the same manner as in Example 6 except that a second intermediate layer was formed as follows, and was evaluated in the same manner. The results are shown in Table 14.

Electron transporting substance (A101) (4 parts), Crosslinking agent (B1:protecting group (H1)=5.1:2.2 (mass ratio)) (7.3 parts), Resin (D1) (0.9 parts) and dioctyltin laurate (0.05 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto the first intermediate layer by immersion coating. The resulting coating was heated for 40 minutes at 170° C. to be polymerized to form a second intermediate layer having a thickness of 0.52 μm.

The content of the electron transporting substance was 33% by mass based on the total mass of the composition.

### Example 57

An electrophotographic photosensitive member was produced in the same manner as in Example 6 except that a second intermediate layer was formed as follows, and was evaluated in the same manner. The results are shown in Table 14.

Electron transporting substance (A-114) (6 parts), Amine compound (C1-3) (2.1 parts), Resin (D1) (0.5 parts) and dodecylbenzenesulfonic acid (0.1 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto the first intermediate layer by immersion coating. The resulting coating was heated for 40 minutes at 170° C. to be polymerized to form a second intermediate layer having a thickness of 0.49 μm.

The content of the electron transporting substance was 70% by mass based on the total mass of the composition.

### Example 58

An electrophotographic photosensitive member was produced in the same manner as in Example 6 except that a second intermediate layer was formed as follows, and was evaluated in the same manner. The results are shown in Table 14.

Electron transporting substance (A-114) (6.5 parts), Amine compound (C1-3) (2.1 parts), Resin (D1) (0.4 parts) and dodecylbenzenesulfonic acid (0.1 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto the first intermediate layer by immersion coating. The resulting coating was heated for 40 minutes at 170° C. to be polymerized to form a second intermediate layer having a thickness of 0.49 μm.

The content of the electron transporting substance was 72% by mass based on the total mass of the composition.

### Examples 59 to 62

The thickness of the first intermediate layer was changed from 1.5 μm to 1.0 μm (Example 59), 2.5 μm (Example 60), 3.2 μm (Example 61) and 7.3 μm (Example 62) as shown in Table 14. Except for these, electrophotographic photosensitive members were produced in the same manner as in Example 6, and were evaluated in the same manner as in Example 6. The results are shown in Table 14.

### Examples 63 to 65

The thickness of the second intermediate layer was changed form 0.52 μm to 0.40 μm (Example 63), 0.26 μm (Example 64) and 0.61 μm (Example 65) as shown in Table 14. Except for these, electrophotographic photosensitive members were produced in the same manner as in Example 6, and were evaluated in the same manner as in Example 6. The results are shown in Table 14.

### Examples 66 and 67

The thickness of the first intermediate layer was changed from 1.5 μm to 0.35 μm (Example 66) and 0.4 μm (Example 67) and the thickness of the second intermediate layer was changed form 0.52 μm to 0.80 μm (Examples 66 and 67) as shown in Table 14. Except for these, electrophotographic photosensitive members were produced in the same manner as in Example 6, and were evaluated in the same manner as in Example 6. The results are shown in Table 14.

### Examples 68 to 70)

Electrophotographic photosensitive members were produced in the same manner as in Example 49 except that first intermediate layers were formed with coating solutions for a first intermediate layer as shown in Table 14, and were evaluated in the same manner. The results are shown in Table 14.

### Examples 71 and 72

Electrophotographic photosensitive members were produced in the same manner as in Example 55 except that first intermediate layers were formed with coating solutions for a first intermediate layer as shown in Table 14, and were evaluated in the same manner. The results are shown in Table 14.

### Example 73

An electrophotographic photosensitive member was produced in the same manner as in Example 6 except that a first intermediate layer was formed with a coating solution for a first intermediate layer as shown in Table 14, and was evaluated in the same manner. The results are shown in Table 14.

### Example 74

An electrophotographic photosensitive member was produced in the same manner as in Example 6 except that a first intermediate layer was formed with a coating solution for a first intermediate layer as shown in Table 14, and was evaluated in the same manner. The results are shown in Table 14.

### Example 75

An electrophotographic photosensitive member was produced in the same manner as in Example 1 except that Resin (D1) was not added to the coating solution for a second intermediate layer used in Example 1, and was evaluated in the same manner. The results are shown in Table 14

### Example 76

An electrophotographic photosensitive member was produced in the same manner as in Example 29 except that Resin (D1) was not added to the coating solution for a second intermediate layer used in Example 29, and was evaluated in the same manner. The results are shown in Table 14.

### Example 77

An electrophotographic photosensitive member was produced in the same manner as in Example 1 except that a charge generating layer was formed as follows, and was evaluated in the same manner. The results are shown in Table 14.

Using oxytitanium phthalocyanine (10 parts) having peaks at Bragg angles 2θ±0.2°) of 9.0°, 14.2°, 23.9° and 27.1° in CuKα X ray diffraction, a polyvinyl butyral resin (trade name: S-LEC BX-1, manufactured by Sekisui Chemical Co., Ltd.) was dissolved in a mixed solvent of cyclohexanone:water=97:3 to prepare a 5% by mass solution (166 parts). The solution and a mixed solvent (150 parts) of cyclohexanone:water=97:3 were dispersed for 4 hours with 1 mmφ glass beads (400 parts) in a sand mill. Then, a mixed solvent of cyclohexanone:water=97:3 (210 parts) and cyclohexanone (260 parts) were added to prepare a coating solution for a charge generating layer. The coating solution for a charge generating layer was applied onto a second intermediate layer by immersion coating. The resulting coating was dried at 80° C. for 10 minutes to form a charge generating layer having a thickness of 0.20 μm.

### Example 78

An electrophotographic photosensitive member was produced in the same manner as in Example 1 except that a charge generating layer was formed as follows, and was evaluated in the same manner. The results are shown in Table 14.

A bisazo pigment represented by Formula (11) (20 parts) and a polyvinyl butyral resin (trade name: S-LEC BX-1, manufactured by Sekisui Chemical Co., Ltd.) (10 parts) were mixed and dispersed in tetrahydrofuran (150 parts) to prepare a coating solution for a charge generating layer. The coating solution for a charge generating layer was applied onto a second intermediate layer by immersion coating. The resulting coating was dried at 110° C. for 30 minutes to form a charge generating layer having a thickness of 0.30 μm.

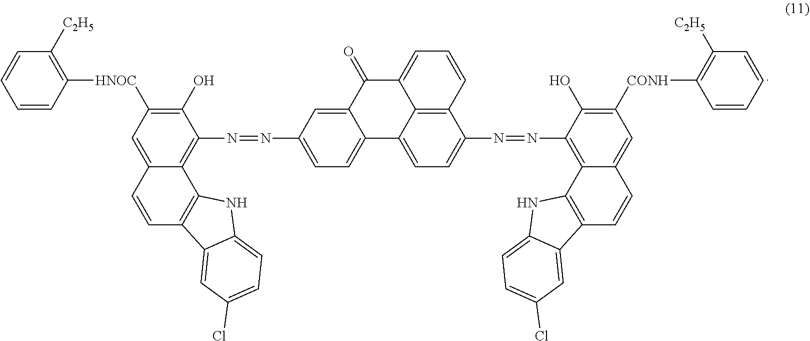

### Comparative Examples 1 to 6

Electrophotographic photosensitive members were produced in the same manner as in Examples 1 to 6, respectively, except that second intermediate layers in Examples 1 to 6 were not provided and charge generating layers were formed on first intermediate layers, and was evaluated in the same manner. The results are shown in Table 14.

### Comparative Examples 7 to 13

Electrophotographic photosensitive members were produced in the same manner as in Examples 68 to 74, respectively, except that second intermediate layers in Examples 68 to 74 were not provided and charge generating layers were formed on first intermediate layers, and was evaluated in the same manner. The results are shown in Table 14.

### Comparative Example 14

An electrophotographic photosensitive member was produced in the same manner as in Example 1 except that the amount of Electron transporting substance (A101) to be added in the second intermediate layer was changed from 4 parts to 1.5 parts, and was evaluated in the same manner. The results are shown in Table 14. The content of Electron transporting substance (A101) was 21% by mass based on the composition.

### Comparative Example 15

An electrophotographic photosensitive member was produced in the same manner as in Example 25 except that Coating solution for first intermediate layer 1 was applied to form a first intermediate layer having a thickness of 25 μm, and a second intermediate layer was formed as follows, and was evaluated in the same manner. The results are shown in Table 14.

Alizarin (A907) (5 parts), Crosslinking agent [B1:protecting group (H1)=5.1:2.2 (mass ratio)] (13.5 parts), Resin (D1) (10 parts) and dioctyltin laurate (0.05 parts) as a catalyst were dissolved in a mixed solvent of dimethylacetamide (100 parts) and methyl ethyl ketone (100 parts) to prepare a coating solution for a second intermediate layer. The coating solution for a second intermediate layer was applied onto a first intermediate layer by immersion coating to form a coating. The resulting coating was heated for 40 minutes at a temperature of 170° C. to be cured to form a second intermediate layer having a thickness of 1.0 μm. The content of Electron transporting substance (A907) was 18% by mass based on the composition.

<Elution Test>

The coating solutions for a second intermediate layer prepared in Examples 1 to 78 (0.5 g) were each applied onto aluminum sheets uniformly by wire bar coating. The resulting coatings were heated at a temperature of 160° C. for 30 minutes to be polymerized (cured). Samples were prepared. In each of the samples, a piece measuring 100 mm×50 mm was cut from the central portion of the sample, and was immersed in a mixed solution of anone and ethyl acetate (weight ratio=1:1) at a temperature of 20° C. for 10 minutes. The initial weight before immersion and the weight after immersion were measured. The coating formed on the sample was scraped off, and the weight of the aluminum sheet was measured. The weight reduction rate after immersion (amount of elution, %) was determined form the following expression:

weight reduction rate after immersion (%)=((initial weight−weight after immersion)/initial weight−weight of aluminum sheet))×100

When the weight reduction rate after immersion (%) is 5% or less, it was determined that the second intermediate layer barely elutes. As a result, undercoat layers formed in Examples 1 to 78 had weight reduction rates after immersion (%) of 5% or less, and barely eluted.

TABLE 13

| | | | | Second intermediate layer | | | | | Second intermediate | | | | |
|---|---|---|---|---|---|---|---|---|---|---|---|---|---|
| | | | | | | | Amount of electron | | layer/first | | | | |
| | First intermediate layer | | | | | | transporting | | intermediate layer | | Evaluation | | |
| | Coating solution | Amount of | | Electron | | | substance/total | | Ratio of | Ratio of | on environment | Residual | |
| | for first | titanium | Thickness | transporting | Crosslinking | | amount of | Thickness | content | thickness | potential | potential | Evaluation on |
| Example | intermediate layer | oxide/total mass (—) | (μm) | substance | agent | Resin | composition (%) | (μm) | (—) | (—) | ΔV1 (V) | Vr (V) | leakage |
| 1 | Coating solution 1 | 0.75 | 1.5 | A101 | B1 | D1 | 41 | 0.52 | 0.55 | 0.35 | 11 | 18 | A |
| 2 | Coating solution 2 | 0.75 | 1.5 | A101 | B1 | D1 | 41 | 0.52 | 0.55 | 0.35 | 12 | 21 | A |
| 3 | Coating solution 3 | 0.80 | 1.5 | A101 | B1 | D1 | 41 | 0.52 | 0.51 | 0.35 | 12 | 22 | A |
| 4 | Coating solution 4 | 0.80 | 1.5 | A101 | B1 | D1 | 41 | 0.52 | 0.51 | 0.35 | 11 | 22 | A |
| 5 | Coating solution 5 | 0.80 | 1.5 | A101 | B1 | D1 | 41 | 0.52 | 0.51 | 0.35 | 10 | 18 | A |
| 6 | Coating solution 6 | 0.75 | 1.5 | A101 | B1 | D1 | 41 | 0.52 | 0.55 | 0.35 | 10 | 18 | A |
| 7 | Coating solution 6 | 0.75 | 1.5 | A103 | B1 | D1 | 41 | 0.52 | 0.55 | 0.35 | 11 | 20 | A |
| 8 | Coating solution 6 | 0.75 | 1.5 | A105 | B1 | D1 | 41 | 0.52 | 0.55 | 0.35 | 11 | 18 | A |
| 9 | Coating solution 6 | 0.75 | 1.5 | A109 | B1 | D1 | 41 | 0.52 | 0.55 | 0.35 | 10 | 24 | A |
| 10 | Coating solution 6 | 0.75 | 1.5 | A113 | B1 | D1 | 41 | 0.52 | 0.55 | 0.35 | 14 | 21 | A |
| 11 | Coating solution 6 | 0.75 | 1.5 | A114 | B1 | D1 | 41 | 0.52 | 0.55 | 0.35 | 13 | 18 | A |
| 12 | Coating solution 6 | 0.75 | 1.5 | A115 | B1 | D1 | 41 | 0.52 | 0.55 | 0.35 | 13 | 15 | A |
| 13 | Coating solution 6 | 0.75 | 1.5 | A116 | B1 | D1 | 41 | 0.52 | 0.55 | 0.35 | 12 | 21 | A |
| 14 | Coating solution 6 | 0.75 | 1.5 | A117 | B1 | D1 | 41 | 0.52 | 0.55 | 0.35 | 11 | 20 | A |
| 15 | Coating solution 6 | 0.75 | 1.5 | A201 | B1 | D1 | 41 | 0.52 | 0.55 | 0.35 | 12 | 19 | A |
| 16 | Coating solution 6 | 0.75 | 1.5 | A301 | B1 | D1 | 41 | 0.52 | 0.55 | 0.35 | 10 | 17 | A |
| 17 | Coating solution 6 | 0.75 | 1.5 | A401 | B1 | D1 | 41 | 0.52 | 0.55 | 0.35 | 10 | 17 | A |
| 18 | Coating solution 6 | 0.75 | 1.5 | A501 | B1 | D1 | 41 | 0.52 | 0.55 | 0.35 | 12 | 21 | A |
| 19 | Coating solution 6 | 0.75 | 1.5 | A601 | B1 | D1 | 41 | 0.52 | 0.55 | 0.35 | 10 | 20 | A |
| 20 | Coating solution 6 | 0.75 | 1.5 | A701 | B1 | D1 | 41 | 0.52 | 0.55 | 0.35 | 10 | 19 | A |
| 21 | Coating solution 6 | 0.75 | 1.5 | A801 | B1 | D1 | 41 | 0.52 | 0.55 | 0.35 | 12 | 17 | A |
| 22 | Coating solution 6 | 0.75 | 1.5 | A901 | B1 | D1 | 41 | 0.52 | 0.55 | 0.35 | 13 | 19 | A |
| 23 | Coating solution 6 | 0.75 | 1.5 | A1001 | B1 | D1 | 41 | 0.52 | 0.55 | 0.35 | 11 | 20 | A |
| 24 | Coating solution 6 | 0.75 | 1.5 | A1101 | B1 | D1 | 41 | 0.52 | 0.55 | 0.35 | 11 | 18 | A |
| 25 | Coating solution 6 | 0.75 | 1.5 | A101 | B1 | D3 | 41 | 0.52 | 0.55 | 0.35 | 11 | 22 | A |
| 26 | Coating solution 6 | 0.75 | 1.5 | A101 | B1 | D5 | 41 | 0.52 | 0.55 | 0.35 | 11 | 16 | A |
| 27 | Coating solution 6 | 0.75 | 1.5 | A101 | B1 | D18 | 41 | 0.52 | 0.55 | 0.35 | 12 | 15 | A |
| 28 | Coating solution 6 | 0.75 | 1.5 | A101 | B1 | D21 | 41 | 0.52 | 0.55 | 0.35 | 10 | 22 | A |
| 29 | Coating solution 4 | 0.80 | 1.5 | A101 | B1 | D1 | 41 | 0.52 | 0.51 | 0.35 | 11 | 20 | A |
| 30 | Coating solution 4 | 0.80 | 1.5 | A103 | B1 | D1 | 41 | 0.52 | 0.51 | 0.35 | 13 | 21 | A |
| 31 | Coating solution 4 | 0.80 | 1.5 | A114 | B1 | D1 | 41 | 0.52 | 0.51 | 0.35 | 10 | 15 | A |
| 32 | Coating solution 4 | 0.80 | 1.5 | A117 | B1 | D1 | 41 | 0.52 | 0.51 | 0.35 | 12 | 23 | A |
| 33 | Coating solution 4 | 0.80 | 1.5 | A201 | B1 | D1 | 41 | 0.52 | 0.51 | 0.35 | 11 | 23 | A |
| 34 | Coating solution 4 | 0.80 | 1.5 | A301 | B1 | D1 | 41 | 0.52 | 0.51 | 0.35 | 11 | 17 | A |
| 35 | Coating solution 4 | 0.80 | 1.5 | A401 | B1 | D1 | 41 | 0.52 | 0.51 | 0.35 | 10 | 15 | A |
| 36 | Coating solution 4 | 0.80 | 1.5 | A501 | B1 | D1 | 41 | 0.52 | 0.51 | 0.35 | 13 | 22 | A |
| 37 | Coating solution 4 | 0.80 | 1.5 | A601 | B1 | D1 | 41 | 0.52 | 0.51 | 0.35 | 14 | 15 | A |
| 38 | Coating solution 4 | 0.80 | 1.5 | A701 | B1 | D1 | 41 | 0.52 | 0.51 | 0.35 | 12 | 17 | A |
| 39 | Coating solution 4 | 0.80 | 1.5 | A801 | B1 | D1 | 41 | 0.52 | 0.51 | 0.35 | 10 | 24 | A |
| 40 | Coating solution 4 | 0.80 | 1.5 | A901 | B1 | D1 | 41 | 0.52 | 0.51 | 0.35 | 10 | 19 | A |
| 41 | Coating solution 4 | 0.80 | 1.5 | A1001 | B1 | D1 | 41 | 0.52 | 0.51 | 0.35 | 13 | 15 | A |
| 42 | Coating solution 4 | 0.80 | 1.5 | A1101 | B1 | D1 | 41 | 0.52 | 0.51 | 0.35 | 11 | 20 | A |
| 43 | Coating solution 4 | 0.80 | 1.5 | A101 | B1:H2 | D1 | 41 | 0.52 | 0.51 | 0.35 | 13 | 19 | A |
| 44 | Coating solution 4 | 0.80 | 1.5 | A101 | B1:H3 | D1 | 41 | 0.52 | 0.51 | 0.35 | 10 | 24 | A |
| 45 | Coating solution 4 | 0.80 | 1.5 | A101 | B4:H1 | D1 | 41 | 0.52 | 0.51 | 0.35 | 12 | 22 | A |
| 46 | Coating solution 4 | 0.80 | 1.5 | A101 | B5:H1 | D1 | 41 | 0.52 | 0.51 | 0.35 | 11 | 20 | A |
| 47 | Coating solution 4 | 0.80 | 1.5 | A101 | B7:H1 | D1 | 41 | 0.52 | 0.51 | 0.35 | 13 | 16 | A |
| 48 | Coating solution 4 | 0.80 | 1.5 | A101 | B12:H1 | D1 | 41 | 0.52 | 0.51 | 0.35 | 10 | 24 | A |
| 49 | Coating solution 4 | 0.80 | 1.5 | A101 | C1-1 | D1 | 57 | 0.68 | 0.71 | 0.45 | 12 | 24 | A |
| 50 | Coating solution 4 | 0.80 | 1.5 | A101 | C1-3 | D1 | 57 | 0.68 | 0.71 | 0.45 | 12 | 22 | A |
| 51 | Coating solution 4 | 0.80 | 1.5 | A101 | C1-9 | D1 | 42 | 0.68 | 0.53 | 0.45 | 14 | 23 | A |
| 52 | Coating solution 4 | 0.80 | 1.5 | A101 | C2-1 | D1 | 42 | 0.68 | 0.53 | 0.45 | 12 | 18 | A |
| 53 | Coating solution 4 | 0.80 | 1.5 | A101 | C3-3 | D1 | 42 | 0.68 | 0.53 | 0.45 | 11 | 21 | A |

TABLE 14

| | | | | | | | | | Second | | | | |
|---|---|---|---|---|---|---|---|---|---|---|---|---|---|
| | | | | | | | | | intermediate | | | | |
| | | | | | | | | | layer/first | | | | |
| | First intermediate layer | | | Second intermediate layer | | | | | intermediate layer | | Evaluation | | |
| | Coating | Amount of titanium | | Electron | | | Amount of electron | | Ratio of | Ratio of | on environment | Residual | |
| | solution for first | oxide/total | Thickness | transporting | Crosslinking | | transporting substance/total | Thickness | content | thickness | potential | potential | Evaluation on |
| | intermediate layer | mass (—) | (μm) | substance | agent | Resin | amount of composition (%) | (μm) | (—) | (—) | ΔVI (V) | Vr (V) | leakage |
| Example | | | | | | | | | | | | | |
| 54 | Coating solution 6 | 0.75 | 1.5 | A101 | B1 | D1 | 25 | 0.52 | 0.33 | 0.35 | 11 | 35 | A |
| 55 | Coating solution 6 | 0.75 | 1.5 | A101 | B1 | D1 | 30 | 0.52 | 0.40 | 0.35 | 12 | 28 | A |
| 56 | Coating solution 6 | 0.75 | 1.5 | A101 | B1 | D1 | 33 | 0.52 | 0.44 | 0.35 | 13 | 20 | A |
| 57 | Coating solution 6 | 0.75 | 1.5 | A114 | C1-3 | D1 | 70 | 0.49 | 0.93 | 0.33 | 13 | 15 | A |
| 58 | Coating solution 6 | 0.75 | 1.5 | A114 | C1-3 | D1 | 72 | 0.49 | 0.96 | 0.33 | 14 | 16 | B |
| 59 | Coating solution 6 | 0.75 | 1 | A101 | B1 | D1 | 41 | 0.52 | 0.55 | 0.52 | 14 | 24 | A |
| 60 | Coating solution 6 | 0.75 | 2.5 | A101 | B1 | D1 | 41 | 0.52 | 0.55 | 0.21 | 11 | 17 | A |
| 61 | Coating solution 6 | 0.75 | 3.2 | A101 | B1 | D1 | 41 | 0.52 | 0.55 | 0.16 | 14 | 16 | A |
| 62 | Coating solution 6 | 0.75 | 7.3 | A101 | B1 | D1 | 41 | 0.52 | 0.55 | 0.07 | 18 | 22 | A |
| 63 | Coating solution 6 | 0.75 | 1.5 | A101 | B1 | D1 | 41 | 0.4 | 0.55 | 0.27 | 14 | 17 | A |
| 64 | Coating solution 6 | 0.75 | 1.5 | A101 | B1 | D1 | 41 | 0.26 | 0.55 | 0.17 | 14 | 23 | A |
| 65 | Coating solution 6 | 0.75 | 1.5 | A101 | B1 | D1 | 41 | 0.61 | 0.55 | 0.41 | 10 | 20 | A |
| 66 | Coating solution 6 | 0.75 | 0.35 | A101 | B1 | D1 | 41 | 0.8 | 0.55 | 2.29 | 13 | 38 | A |
| 67 | Coating solution 6 | 0.75 | 0.4 | A101 | B1 | D1 | 41 | 0.8 | 0.55 | 2.00 | 14 | 21 | A |
| 68 | Coating solution 7 | 0.50 | 2 | A101 | B1 | D1 | 57 | 0.52 | 1.14 | 0.26 | 10 | 32 | A |
| 69 | Coating solution 8 | 0.58 | 2 | A101 | B1 | D1 | 57 | 0.52 | 0.98 | 0.26 | 14 | 16 | A |
| 70 | Coating solution 9 | 0.67 | 2 | A101 | B1 | D1 | 57 | 0.52 | 0.86 | 0.26 | 13 | 19 | A |
| 71 | Coating solution 10 | 0.88 | 2 | A101 | B1 | D1 | 30 | 0.52 | 0.34 | 0.26 | 10 | 23 | A |
| 72 | Coating solution 11 | 0.95 | 2 | A101 | B1 | D1 | 30 | 0.52 | 0.32 | 0.26 | 20 | 15 | A |
| 73 | Coating solution 12 | 0.75 | 1.5 | A101 | B1 | D1 | 41 | 0.52 | 0.55 | 0.35 | 18 | 23 | A |
| 74 | Coating solution 13 | 0.75 | 1.5 | A101 | B1 | D1 | 41 | 0.52 | 0.55 | 0.35 | 10 | 21 | A |
| 75 | Coating solution 1 | 0.75 | 1.5 | A101 | B1 | None | 42 | 0.52 | 0.56 | 0.35 | 10 | 19 | B |
| 76 | Coating solution 4 | 0.80 | 1.5 | A101 | B1 | None | 42 | 0.52 | 0.53 | 0.35 | 13 | 23 | B |
| 77 | Coating solution 1 | 0.75 | 1.5 | A101 | B1 | D1 | 41 | 0.52 | 0.55 | 0.35 | 12 | 32 | A |
| 78 | Coating solution 1 | 0.75 | 1.5 | A101 | B1 | D1 | 41 | 0.52 | 0.55 | 0.35 | 14 | 30 | A |
| Comparative | | | | | | | | | | | | | |
| Example | | | | | | | | | | | | | |
| 1 | Coating solution 1 | 0.75 | 1.5 | None | | | | | — | — | 35 | 20 | D |
| 2 | Coating solution 2 | 0.75 | 1.5 | None | | | | | — | — | 25 | 15 | D |
| 3 | Coating solution 3 | 0.80 | 1.5 | None | | | | | — | — | 43 | 24 | D |
| 4 | Coating solution 4 | 0.80 | 1.5 | None | | | | | — | — | 28 | 22 | D |
| 5 | Coating solution 5 | 0.80 | 1.5 | None | | | | | — | — | 50 | 15 | D |
| 6 | Coating solution 6 | 0.75 | 1.5 | None | | | | | — | — | 45 | 16 | D |
| 7 | Coating solution 7 | 0.50 | 2 | None | | | | | — | — | 35 | 23 | D |
| 8 | Coating solution 8 | 0.60 | 2 | None | | | | | — | — | 46 | 22 | D |
| 9 | Coating solution 9 | 0.67 | 2 | None | | | | | — | — | 32 | 23 | D |
| 10 | Coating solution 10 | 0.83 | 2 | None | | | | | — | — | 22 | 15 | D |
| 11 | Coating solution 11 | 0.91 | 2 | None | | | | | — | — | 25 | 17 | D |
| 12 | Coating solution 12 | 0.75 | 1.5 | None | | | | | — | — | 34 | 16 | E |
| 13 | Coating solution 13 | 0.75 | 1.5 | None | | | | | — | — | 36 | 16 | C |
| 14 | Coating solution 1 | 0.75 | 1.5 | A101 | B1 | D1 | 21 | 0.52 | 0.28 | 0.35 | 15 | 57 | A |
| 15 | Coating solution 1 | 0.75 | 1.5 | A907 | B1 | D1 | 18 | 1.00 | 0.23 | 0.67 | 20 | 68 | B |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-270566, filed Dec. 26, 2013, and Japanese Patent Application No. 2014-243107, filed Dec. 1, 2014, which are hereby incorporated by reference herein in their entirety.

What is claimed is:

1. An electrophotographic photosensitive member comprising:
a support;
a first intermediate layer formed on the support;
a second intermediate layer formed directly on the first intermediate layer;
a charge generating layer formed directly on the second intermediate layer; and
a hole transporting layer formed on the charge generating layer,
wherein the first intermediate layer comprises a binder resin and a titanium oxide particle, and
the second intermediate layer comprises a polymerized product of a composition comprising:
an electron transporting substance having a polymerizable functional group; and
a crosslinking agent,
wherein the content of the electron transporting substance in the second intermediate layer is 25% by mass or more based on the total mass of the composition.

2. The electrophotographic photosensitive member according to claim 1, wherein the content of the electron transporting substance is 30% by mass or more and 70% by mass or less based on the total mass of the composition.

3. The electrophotographic photosensitive member according to claim 1, wherein the thickness of the second intermediate layer is ⅙ to 2 times the thickness of the first intermediate layer.

4. The electrophotographic photosensitive member according to claim 1, wherein the content of the electron transporting substance based on the total mass of the composition of the second intermediate layer is ⅓ to 1 time the content of the titanium oxide particle based on the total mass of the first intermediate layer.

5. The electrophotographic photosensitive member according to claim 1, wherein the titanium oxide particle has a volume average particle size of 260 nm or less.

6. The electrophotographic photosensitive member according to claim 1, wherein the composition of the second intermediate layer further comprises a thermoplastic resin having a polymerizable functional group.

7. The electrophotographic photosensitive member according to claim 6, wherein the polymerizable functional group of the thermoplastic resin is one selected from the group consisting of a hydroxy group, a thiol group, an amino group, a carboxyl group and a methoxy group.

8. The electrophotographic photosensitive member according to claim 1, wherein the polymerizable functional group of the electron transporting substance is one selected from the group consisting of a hydroxy group, a thiol group, an amino group, a carboxyl group and a methoxy group.

9. The electrophotographic photosensitive member according to claim 1, wherein the titanium oxide particle is a titanium oxide particle whose surface has not been treated with a surface treating agent.

10. The electrophotographic photosensitive member according to claim 1, wherein the titanium oxide particle is a titanium oxide particle whose surface has been treated with a surface treating agent, and an amount of the surface treating agent used in the surface treatment is 5% by mass or less.

11. A process cartridge integrally supporting the electrophotographic photosensitive member according to claim 1 and at least one unit selected from the group consisting of a charging unit, a developing unit and a cleaning unit, the process cartridge being attachable to and detachable from an electrophotographic apparatus.

12. An electrophotographic apparatus comprising the electrophotographic photosensitive member according to claim 1, an exposing unit, a charging unit, a developing unit and a transfer unit.
